(19) United States
(12) Patent Application Publication
(10) Pub. No.: US 2026/0261307 A1
(43) Pub. Date: Sep. 3, 2026

(54) DELIVERY OF CHANNEL STATE INFORMATION

(71) Applicant: Nokia Technologies Oy, Espoo (FI)

(72) Inventors: Orhan Okan MUTGAN, Munich (DE); Prabodh VARSHNEY, Dallas, TX (US); Juhyung LEE, Sunnyvale, CA (US); Salvatore TALARICO, Sunnyvale, CA (US); Mikhail LIUBOGOSHCHEV, Munich (DE)

(21) Appl. No.: 19/066,726

(22) Filed: Feb. 28, 2025

(51) Int. Cl. H04B 7/06; H04W 72/30

(52) U.S. Cl. CPC H04B 7/0626; H04W 72/30

(57) ABSTRACT

Embodiments of the present disclosure relate to delivery of channel state information. An apparatus receives, from a plurality of access point (AP) devices, a plurality of sounding sequences. The plurality of AP devices comprises a first AP device and at least a second AP device. The apparatus determines respective channel state information (CSIs) of a plurality of channels between the apparatus and the plurality of AP devices based on the plurality of sounding sequences. The apparatus transmits, to the first AP device, a first frame comprising information indicative of the respective CSIs of the plurality of channels and first identifier information associated with the plurality of AP devices.

### FIELD

Various example embodiments relate to the field of telecommunication and in particular, to methods, devices, apparatuses and computer readable storage medium for delivery of channel state information.

### BACKGROUND

A communication network can be seen as a facility that enables communications between two or more communication devices, or provides communication devices access to a data network. A wireless communication network is one example of a communication network.

Such communication networks may operate in accordance with standards, such as those promulgated by Third Generation Partnership Project (3GPP) or Institute of Electrical and Electronics Engineers (IEEE). For example, 3GPP standards cover cellular communication networks from the first generation (1G) to the fifth generation (5G) and beyond. IEEE standards cover a variety of wired and wireless communication technologies used in Local Area Networks (LANs), Personal Area Networks (PANs), Broadband Wireless Access (BWA) and so on. These standards ensure interoperability, performance, and reliability within a communication network and across different communication networks.

### SUMMARY

In general, example embodiments of the present disclosure provide a solution for delivery of channel state information.

In a first aspect, there is provided an apparatus. The apparatus comprises at least one processor; and at least one memory storing instructions. When executed by the at least one processor, the instructions cause the apparatus at least to: receive, from a plurality of access point (AP) devices, a plurality of sounding sequences, wherein the plurality of AP devices comprises a first AP device and at least a second AP device; determine respective channel state information (CSIs) of a plurality of channels between the apparatus and the plurality of AP devices based on the plurality of sounding sequences; and transmit, to the first AP device, a first frame comprising information indicative of the respective CSIs of the plurality of channels and first identifier information associated with the plurality of AP devices.

In a second aspect, there is provided a first apparatus. The first apparatus comprises at least one processor; and at least one memory storing instructions. When executed by the at least one processor, the instructions cause the first apparatus at least to: transmit, to a non-access point (non-AP) station, a sounding sequence; receive, from the non-AP station, a first frame comprising information indicative of respective channel state information (CSI) of a plurality of channels between the non-AP station and a plurality of apparatuses comprising the first apparatus and at least a second apparatus; and transmit, to the at least a second apparatus, at least a CSI of at least a channel between the non-AP station and the at least a second apparatus.

In a third aspect, there is provided a second apparatus. The second apparatus comprises at least one processor; and at least one memory storing instructions. When executed by the at least one processor, the instructions cause the second apparatus at least to: transmit, to a non-access point (non-AP) station, a sounding sequence; and receive, from a first apparatus, channel state information (CSI) of a channel between the non-AP station and the second apparatus.

In a fourth aspect, there is provided an apparatus. The apparatus comprises at least one processor; and at least one memory storing instructions. When executed by the at least one processor, the instructions cause the apparatus at least to: receive, from a plurality of access point (AP) devices, a plurality of sounding sequences; determine respective channel state information (CSIs) of a plurality of channels between the apparatus and the plurality of AP devices based on the plurality of sounding sequences; and transmit, to the plurality of AP devices, a frame comprising information indicative of the respective CSIs of the plurality of channels and identifier information associated with the plurality of AP devices.

In a fifth aspect, there is provided an apparatus. The apparatus comprises at least one processor; and at least one memory storing instructions. When executed by the at least one processor, the instructions cause the apparatus at least to: transmit, to a non-access point (non-AP) station, a sounding sequence; and receive, from the non-AP station, a frame comprising information indicative of respective channel state information (CSIs) of a plurality of channels between the non-AP station and a plurality of apparatuses comprising the apparatus and identifier information associated with the plurality of apparatuses

In a sixth aspect, there is provided an apparatus. The apparatus comprises at least one processor; and at least one memory storing instructions. When executed by the at least one processor, the instructions cause the apparatus at least to: receive, from a plurality of access point (AP) devices, a plurality of sounding sequences, wherein the plurality of AP devices comprises a first AP device and at least a second AP device; receive, from the first AP device, a trigger frame comprising identifier information associated with the plurality of AP devices; and transmit, to the first AP device or to the plurality of AP devices, a frame comprising information indicative of respective channel state information (CSIs) of a plurality of channels between the apparatus and the plurality of AP devices.

In a seventh aspect, there is provided a first apparatus. The first apparatus comprises at least one processor; and at least one memory storing instructions. When executed by the at least one processor, the instructions cause the first apparatus at least to: transmit, to a non-access point (non-AP) station, a sounding sequence; transmit, to the non-AP station, a trigger frame, wherein the trigger frame comprises identifier information associated with a plurality of apparatuses comprising the first apparatus and at least a second apparatus; and receive, from the non-AP station, a frame comprising information indicative of respective channel state information (CSIs) of a plurality of channels between the non-AP station and a plurality of apparatuses.

In an eighth, there is provided a method implemented at an apparatus. The method comprises: receiving, at an apparatus from a plurality of access point (AP) devices, a plurality of sounding sequences, wherein the plurality of AP devices comprises a first AP device and at least a second AP device; determining respective channel state information (CSIs) of a plurality of channels between the apparatus and the plurality of AP devices based on the plurality of sounding sequences; and transmitting, to the first AP device, a first frame comprising information indicative of the respective CSIs of the plurality of channels and first identifier information associated with the plurality of AP devices.

In a ninth aspect, there is provided a method implemented at a first apparatus. The method comprises: transmitting, at a first apparatus to a non-access point (non-AP) station, a sounding sequence; receiving, from the non-AP station, a first frame comprising information indicative of respective channel state information (CSI) of a plurality of channels between the non-AP station and a plurality of apparatuses comprising the first apparatus and at least a second apparatus; and transmitting, to the at least a second apparatus, at least a CSI of at least a channel between the non-AP station and the at least a second apparatus.

In a tenth aspect, there is provided a method implemented at a second apparatus. The method comprises: transmitting, at a second apparatus to a non-access point (non-AP) station, a sounding sequence; and receiving, from a first apparatus, channel state information (CSI) of a channel between the non-AP station and the second apparatus.

In an eleventh aspect, there is provided a method implemented at an apparatus. The method comprises: receiving, at an apparatus from a plurality of access point (AP) devices, a plurality of sounding sequences; determining respective channel state information (CSIs) of a plurality of channels between the apparatus and the plurality of AP devices based on the plurality of sounding sequences; and transmitting, to the plurality of AP devices, a frame comprising information indicative of the respective CSIs of the plurality of channels and identifier information associated with the plurality of AP devices.

In a twelfth aspect, there is provided a method implemented at an apparatus. The method comprises: transmitting, at an apparatus to a non-access point (non-AP) station, a sounding sequence; and receiving, from the non-AP station, a frame comprising information indicative of respective channel state information (CSIs) of a plurality of channels between the non-AP station and a plurality of apparatuses comprising the apparatus and identifier information associated with the plurality of apparatuses.

In a thirteenth aspect, there is provided a method implemented at an apparatus. The method comprises: receiving, at an apparatus from a plurality of access point (AP) devices, a plurality of sounding sequences, wherein the plurality of AP devices comprises a first AP device and at least a second AP device; receiving, from the first AP device, a trigger frame comprising identifier information associated with the plurality of AP devices; and transmitting, to the first AP device or to the plurality of AP devices, a frame comprising information indicative of respective channel state information (CSIs) of a plurality of channels between the apparatus and the plurality of AP devices.

In a fourteenth aspect, there is provided a method implemented at a first apparatus. The method comprises: transmitting, at a first apparatus to a non-access point (non-AP) station, a sounding sequence; transmitting, to the non-AP station, a trigger frame, wherein the trigger frame comprises identifier information associated with a plurality of apparatuses comprising the first apparatus and at least a second apparatus; and receiving, from the non-AP station, a frame comprising information indicative of respective channel state information (CSIs) of a plurality of channels between the non-AP station and a plurality of apparatuses.

In a fifteenth aspect, there is provided an apparatus. The apparatus comprises means for receiving, from a plurality of access point (AP) devices, a plurality of sounding sequences, wherein the plurality of AP devices comprises a first AP device and at least a second AP device; means for determining respective channel state information (CSIs) of a plurality of channels between the apparatus and the plurality of AP devices based on the plurality of sounding sequences; and means for transmitting, to the first AP device, a first frame comprising information indicative of the respective CSIs of the plurality of channels and first identifier information associated with the plurality of AP devices.

In a sixteenth aspect, there is provided a first apparatus. The apparatus comprises means for transmitting, to a non-access point (non-AP) station, a sounding sequence; means for receiving, from the non-AP station, a first frame comprising information indicative of respective channel state information (CSI) of a plurality of channels between the non-AP station and a plurality of apparatuses comprising the first apparatus and at least a second apparatus; and means for transmitting, to the at least a second apparatus, at least a CSI of at least a channel between the non-AP station and the at least a second apparatus.

In a seventeenth aspect, there is provided a second apparatus. The apparatus comprises means for transmitting, to a non-access point (non-AP) station, a sounding sequence; and means for receiving, from a first apparatus, channel state information (CSI) of a channel between the non-AP station and the second apparatus.

In an eighteenth aspect, there is provided an apparatus. The apparatus comprises means for receiving, from a plurality of access point (AP) devices, a plurality of sounding sequences; means for determining respective channel state information (CSIs) of a plurality of channels between the apparatus and the plurality of AP devices based on the plurality of sounding sequences; and means for transmitting, to the plurality of AP devices, a frame comprising information indicative of the respective CSIs of the plurality of channels and identifier information associated with the plurality of AP devices.

In a nineteenth aspect, there is provided an apparatus. The apparatus comprises means for transmitting, to a non-access point (non-AP) station, a sounding sequence; and means for receiving, from the non-AP station, a frame comprising information indicative of respective channel state information (CSIs) of a plurality of channels between the non-AP station and a plurality of apparatuses comprising the apparatus and identifier information associated with the plurality of apparatuses.

In a twentieth aspect, there is provided an apparatus. The apparatus comprises means for means for receiving, from a plurality of access point (AP) devices, a plurality of sounding sequences, wherein the plurality of AP devices comprises a first AP device and at least a second AP device; means for receiving, from the first AP device, a trigger frame comprising identifier information associated with the plurality of AP devices; and means for transmitting, to the first AP device or to the plurality of AP devices, a frame comprising information indicative of respective channel state information (CSIs) of a plurality of channels between the apparatus and the plurality of AP devices.

In a twenty-first aspect, there is provided a first apparatus. The apparatus comprises means for means for transmitting, to a non-access point (non-AP) station, a sounding sequence; means for transmitting, to the non-AP station, a trigger frame, wherein the trigger frame comprises identifier information associated with a plurality of apparatuses comprising the first apparatus and at least a second apparatus; and means for receiving, from the non-AP station, a frame comprising information indicative of respective channel state information (CSIs) of a plurality of channels between the non-AP station and a plurality of apparatuses.

In a twenty-second aspect, there is provided a non-transitory computer readable medium comprising program instructions for causing an apparatus to perform at least the method according to any one of the above fourth to sixth aspect.

In a twenty-third aspect, there is provided a computer program product comprising program instructions for performing at least the method according to any one of the above fourth to sixth aspects.

In a twenty-fourth aspect, there is provided a computer program comprising instructions, which, when executed by an apparatus, cause the apparatus at least to perform at least the method according to any one of the above fourth to sixth aspects.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1A illustrates an example communication network in which embodiments of the present disclosure may be implemented;

FIG. 1B illustrates an example of a sounding process between a single access point (AP) and a single non-AP station (STA) associated to that AP associated with some embodiments of the present disclosure;

FIG. 1C illustrates an example of a sounding process between a single AP and multiple non-AP STAs associated to that AP associated with some embodiments of the present disclosure;

FIG. 1D illustrates an example of a management frame format associated with some embodiments of the present disclosure;

FIG. 1E illustrates an example format of a MAC frame carrying CSI in IEEE 802.11be associated with some embodiments of the present disclosure;

FIG. 1F illustrates an example of a communication scenario involving multiple APs and multiple non-AP STAs associated with some embodiments of the present disclosure;

FIG. 1G illustrates an example of a sequential sounding process;

FIG. 1H illustrates an example of a joint sounding process;

FIG. 1I illustrates an example of delivery of large CSI from a single non-AP STA to multiple APs in a joint sounding process associated with some embodiments of the present disclosure;

FIG. 1J illustrates an example assumption of an extremely high throughput (EHT) Compressed Beamforming/Channel Quality Indicator (CQI) frame carrying a large CSI;

FIG. 1K illustrates an example assumption of two EHT Compressed Beamforming/CQI frames each targeted at a specific AP.

FIG. 2A illustrates a flowchart illustrating a process for CSI delivery according to some embodiments of the present disclosure;

FIG. 2B illustrates a flowchart illustrating another process for CSI delivery according to some embodiments of the present disclosure;

FIG. 2C illustrates a flowchart illustrating a process of triggering of CSI delivery according to some embodiments of the present disclosure;

FIG. 3 illustrates an example of CSI delivery in a joint sounding process according to some embodiments of the present disclosure;

FIGS. 4A-4H illustrate examples of a single CSI frame transmitted to multiple AP devices according to some embodiments of the present disclosure;

FIG. 5 illustrates another example of CSI delivery in a joint sounding process according to some embodiments of the present disclosure;

FIG. 6 illustrates an example of a single CSI frame carrying CSI associated with multiple AP devices according to some embodiments of the present disclosure;

FIGS. 7A-7C illustrate examples of a CSI frame transmitted from an AP device according to some embodiments of the present disclosure;

FIG. 8 illustrates an example of CSI delivery in a roaming scenario according to some embodiments of the present disclosure;

FIG. 9 illustrates an example of a BFRP frame according to some embodiments of the present disclosure;

FIG. 10 illustrates a flowchart of a method implemented at an apparatus according to some embodiments of the present disclosure;

FIG. 11 illustrates a flowchart of a method implemented at an apparatus according to some embodiments of the present disclosure;

FIG. 12 illustrates a flowchart of a method implemented at an apparatus according to some embodiments of the present disclosure;

FIG. 13 illustrates a flowchart of a method implemented at a first apparatus according to some embodiments of the present disclosure;

FIG. 14 illustrates a flowchart of a method implemented at a second apparatus according to some embodiments of the present disclosure;

FIG. 15 illustrates a flowchart of a method implemented at an apparatus according to some embodiments of the present disclosure;

FIG. 16 illustrates a flowchart of a method implemented at a first apparatus according to some embodiments of the present disclosure;

FIG. 17 illustrates a simplified block diagram of an apparatus that is suitable for implementing embodiments of the present disclosure; and

FIG. 18 illustrates a block diagram of an example computer readable medium in accordance with some embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Global System for Mobile Communications (GSM), General Packet Radio Service (GPRS), Wideband Code Division Multiple Access (WCDMA), Long Term Evolution (LTE), LTE-Advanced (LTE-A), New Radio (5G NR), High-Speed Packet Access (HSPA), Narrow Band Internet of Things (NB-IoT), Wireless Local Area Network (WLANs), Wireless Personal Area Network (WPANs), Worldwide Interoperability for Microwave Access (WiMAXs) and so on. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, a low power node such as a femto, a pico, and so forth, depending on the applied terminology and technology.

As used herein, the term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

WLANs, commonly implemented under IEEE 802.11 standards (i.e., Wireless Fidelity (Wi-Fi)), enables high-speed wireless connectivity across diverse environments, including residential, enterprise, industrial, and public spaces. These networks support bidirectional communication between stations (STAs), facilitating data, voice, and multimedia transmission.

A STA refers to an entity that can be addressed uniquely (i.e., it has a single and unique Medium Access Control (MAC) address) and that provides 802.11 physical (PHY) and MAC functions. STAs can communicate with each other directly. A set of STAs that can communicate with each other form a Basic Service Set (BSS), and the area that their signals cover forms a Basic Service Area (BSA). A STA may be implemented in an access point (AP) or implemented as a non-AP STA depending on its functions.

An AP refers to a device in WLAN that provides wireless devices with wireless access to a wired network. The AP may serve as a hub for the WLAN and may be regarded as a special kind of network device implemented in WLAN. The AP typically has access or an interface to a Distribution System (DS) or another type of wired/wireless network that carries traffic in and out of the BSS. For example, the AP comprises a STA and a DS access function (DSAF) and enables access to the wired network for other STAs over the wireless medium. The AP may be responsible for sending and receiving wireless signals, network connection management and data forwarding. By way of example rather than limitation, an AP may also be referred to as a Wi-Fi router, a Radio Router, a Radio Transceiver, a Transceiver Function (“TF”), a Wireless Access Node, a Wireless Switch, an Access Bridge, or some other terminology, and so forth.

A non-AP STA refers to a wireless device that connects to an AP to access the network. A non-AP STA serves as a user of the WLAN and may be regarded as a special kind of terminal device implemented in WLAN. Non-AP STAs are typically end-user devices that do not provide access to other devices but rather consume network services. By way of example rather than limitation, a non-AP STA may also be referred to as a wireless client, a client STA, a subscriber STA, a subscriber unit, a remote STA, a remote terminal, an end device, an access terminal, a terminal device, a mobile station, a user terminal, a user agent, a user device, user equipment, or some other terminology. Examples of the terminal devices may be implemented as a non-AP STA if located in a WLAN, and duplications thereof will be omitted.

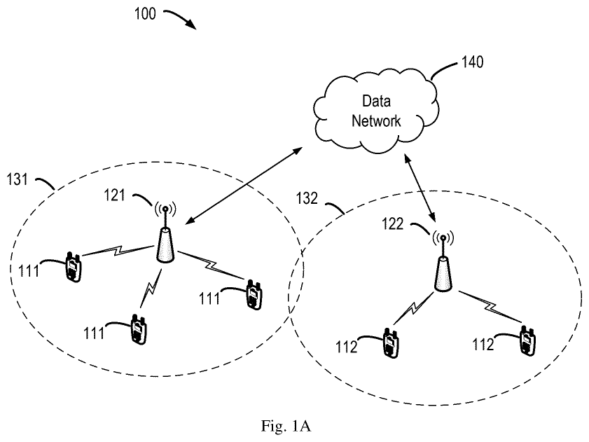

Principle and embodiments of the present disclosure will be described in detail below with reference to the accompanying drawings. Reference is first made to FIG. 1A, which illustrates an example communication system 100 in which embodiments of the present disclosure may be implemented.

The communication system 100 may include at least one non-AP STA (e.g., non-AP STA(s) 111 and non-AP STA(s) 112) and at least one AP (e.g., AP 121 and AP 122). The non-AP STAs 111 and 112 may be mobile devices that are non-stationary (e.g., not having fixed locations) or may be stationary devices. Although the non-AP STAs 111 and 112 are illustrated as mobile phones in FIG. 1A, they may be PDAs, other handheld devices, netbooks, notebook computers, tablet computers, laptops, display devices (e.g., televisions, monitor devices, etc.), printers, etc. The non-AP STA(s) 111 may be within the coverage area 131 of the AP 121 and associated with the AP 121. The non-AP STA(s) 111 may communicate with the AP 121 in accordance with IEEE 802.11 communication standards. The AP 121 may enable the non-AP STA(s) 111 to communicate with other devices coupled to the AP 121. Similarly, the non-AP STA(s) 112 may be within the coverage area 132 of the AP 122 and associated with the AP 122. The non-AP STA(s) 112 may communicate with the AP 122 in accordance with IEEE 802.11 communication standards. The AP 122 may enable the non-AP STA(s) 112 to communicate with other devices coupled to the AP 122. In some implementations, AP 121 and AP 122 may also communicate with each other.

In some embodiments, the communication system 100 may further include a data network 140 (e.g., the Internet or other data networks). The AP 121 may be coupled to the data network 140 and may enable the non-AP STA(s) 111 to access the data network 140 through a DS. The AP 122 may be coupled to the data network 140 and may enable the non-AP STA(s) 112 to access the data network 140 through the DS. The AP 121 and the non-AP STA(s) 111 associated with the AP 121 may form a first BSS. The AP 122 and the non-AP STA(s) 112 associated with the AP 122 may form a second BSS.

It is to be understood that the number of APs and non-AP STAs is only for the purpose of illustration without suggesting any limitations. The communication system 100 may include any suitable number of APs and non-AP STAs adapted for implementing embodiments of the present disclosure. Although not shown, in some implementations, peer-to-peer connections or ad hoc networks may be implemented within the communication system 100.

Communications in the communication system 100 may be implemented according to any proper communication protocol(s), comprising, but not limited to, IEEE 802.11a, IEEE 802.11b, IEEE 802.11g, IEEE 802.11n, IEEE 802.11ac, IEEE 802.11ax, IEEE 802.11be, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

To improve communication performance, channel state information (CSI) of a wireless channel between an AP and a non-STA needs to be required, e.g., in beamforming. For an AP or a non-AP STA to acquire CSI, sounding is needed, i.e., the process of estimating and collecting information (such as CSI) about the wireless channel between a transmitter (e.g., an AP) and a receiver (e.g., a non-AP STA).

FIG. 1B illustrates an example of a sounding process between a single AP and a single non-AP STA associated to that AP. As shown in FIG. 1B, the sounding process starts with the AP sending a Null Data Packet Announcement (NDPA) to the single non-AP STA associated to the AP. After sending the NDPA, the AP sends a Null Data Packet (NDP). The non-AP STA measures the NDP, and calculates/estimates CSI of the channel between the AP and the non-AP STA. The non-AP STA then returns the CSI to the AP.

FIG. 1C illustrates an example of a sounding process between a single AP and multiple non-AP STAs associated to that AP. As shown in FIG. 1C, the sounding process starts with the AP sending an NDPA to the multiple non-AP STAs (e.g., STA1, STA2 and STA3) associated to the AP. After sending the NDPA, the AP sends an NDP. STA1, STA2 and STA3 measure the NDP, and calculate/estimate CSIs of the respective channels between the AP and the non-AP STAs. STA1 sends back the CSI of the channel between the AP and STA1 in response to receiving the NDP. Then, the AP polls each STA of STA2 and STA3 using a Beamforming Report Poll (BFRP) to request STA2 and STA3 to send their respective CSIs.

Although the sounding process varies slightly across different IEEE 802.11 generations (e.g., IEEE 802.11n, IEEE 802.11ac, IEEE 802.11ax, IEEE 802.11be, etc.), each solution follows the high-level procedures depicted in FIG. 1B and FIG. 1C. The MAC frame format to carry CSI changes depending on the 802.11 generation (see Table 1).

TABLE 1
MAC frame format carrying CSI

| Wi-Fi Generation | CSI is carried in: |
|---|---|
| 802.11n | (non-)compressed beamforming frame |
| 802.11ac | very high throughput (VHT) compressed |
| | beamforming frame |
| 802.11ax | high efficiency (HE) compressed |
| | beamforming/CQI frame |
| 802.11be | EHT compressed beamforming/CQI frame |

The frame formats defined in Table 1 are action frames (i.e., a category of management frames) and follow the general Management Frame Format as shown in FIG. 1D. As an example, FIG. 1E illustrates an example of the EHT compressed beamforming/CQI frame format. As shown in FIG. 1D and FIG. 1E, the Address 1 field carries the receiver address (RA) which is the destination address (DA) of the frame. In other words, the Address 1 field carries the MAC address of the non-AP STA receiving the frame or the MAC address of the AP receiving the frame. The Address 2 field carries the transmitter address (TA) which is the source address (SA) of the frame. In other words, the Address 1 field carries the address (e.g., MAC address) of the non-AP STA or the AP transmitting the frame. The Address 3 field carries the BSS identifier (BSSID) of the BSS of the intended recipient(s). For example, the Address 3 field may carry the MAC address of the AP in the BSS. As used herein, the MAC frame carrying CSI may be referred to as a CSI frame.

As an extension of beamforming, coordinated beamforming with null steering (abbreviated as CBF or CoBF) is a technique where multiple APs arrange their transmissions in a way that each AP directs its transmissions to its own non-AP STAs while creating nulls (i.e., an area of extremely low or zero signal strength) towards the non-AP STAs associated with the other APs, thus avoiding interference.

FIG. 1F illustrates an example of a communication scenario involving multiple APs and multiple non-AP STAs associated with some embodiments of the present disclosure. The communication scenario shown in FIG. 1F may be implemented in the communication system 100 in FIG. 1A or other communication systems.

In the example shown in FIG. 1F, there are two APs (e.g., AP1 and AP2) and two non-AP STAs (e.g., STA1 and STA2). As used herein, terms such as “STA1”, “STA2”, “STA3” are refer to non-AP STAs for brevity. STA1 may be associated with AP1 and not associated with AP2. STA2 may be associated with AP2 and not associated with AP1. AP1 may transmit data to STA1, and AP2 may transmit data to STA2. The communication channel between AP1 and STA1 corresponds to H11. The communication channel between AP2 and STA2 corresponds to H22.

When AP1 transmits data towards STA1 through the communication channel H11, the transmission from AP1 to STA1 might cause interference towards STA2 through the channel between AP1 and STA2. Similarly, when AP2 transmits data towards STA2 through communication channel H22, the transmission from AP2 to STA2 might cause interference towards STA1 through the channel between AP2 and STA1. The interference channel between AP1 and STA2 corresponds to H12. The interference channel between AP2 and STA1 corresponds to H21.

With the help of CBF techniques, the interference channels (H12 and H21) can be nulled. In other words, AP1 and AP2 can arrange their transmissions towards their own users (i.e., transmissions from AP1 towards STA1 and transmissions from AP2 towards STA2) in such a way that STA1 only receives transmissions from AP1 and STA2 only receives transmissions from AP2. In other words, STA1 hears “null” (i.e., hearing nothing besides the noise floor) from AP2, and STA2 hears “null” from AP1.

To achieve this, both AP1 and AP2 use precoding vectors by taking into account their corresponding interference channels. In particular, AP1 and AP2 need to acquire CSI from both STA1 and STA2.

More specifically, if AP1 knows H11 (i.e., the communication channel between AP1 and STA1) and H12 (i.e., the interference channel between AP1 and STA2), AP1 can calculate the precoding vector so that AP1's transmissions only go to STA1 (i.e., AP1's own user) while creating null (avoiding interference) towards STA2.

Similarly, if AP2 knows H22 (i.e., the communication channel between AP2 and STA2) and H21 (i.e., the interference channel between AP2 and STA1), AP2 can calculate the precoding vector so that AP2's transmissions only go to STA2 (i.e., AP2's own user) while creating null (avoiding interference) towards STA1.

However, the sounding processes as described with reference to FIG. 1B and FIG. 1C only applies to a single AP (i.e., not multiple APs) and non-AP STA(s) associated with that single AP. Multi-AP sounding is needed to realize CBF. Two mechanism are proposed for the multi-AP sounding, i.e., sequential sounding and joint sounding.

An Ultra High Reliability (UHR) trigger-based (TB) sequential NDP sounding sequence initiated from one AP comprises an EHT TB sounding sequence to collect channel states from its associated non-AP STAs, and a cross-BSS UHR TB sounding sequence for the responding AP to collect channel states from the same non-AP STAs. FIG. 1G illustrates an example of a sequential sounding process. In the example in FIG. 1G, only one non-AP STA associated with AP1 is shown for simplicity. More non-AP STAs associated with AP1 are also possible.

As shown in FIG. 1G, in the EHT TB sounding sequence, AP1 shall transmit an EHT NDPA frame followed after a Short Interframe Space (SIFS) by an EHT sounding NDP from AP1. The EHT sounding NDP shall be followed after a SIFS by the BFRP Trigger frame from AP1. STA1 associated with AP1 shall measure the EHT sounding NDP transmitted by AP1, and transmit CSI of the channel between the STA1 and AP1 to AP1 in an EHT compressed beamforming/CQI frame. Subsequent BFRP Trigger frames, if any, in the EHT TB sounding sequence shall be transmitted a SIFS after the EHT compressed beamforming/CQI frame transmitted in response to the previous BFRP Trigger frame. Each EHT CBF beamformee that is addressed by a BFRP Trigger frame shall respond after a SIFS with an EHT compressed beamforming/CQI frame.

In the cross-BSS UHR TB sounding sequence initiated by AP1, AP1 shall transmit the UHR NDPA frame to solicit the EHT sounding NDP from AP2 (i.e., the responding AP). The UHR NDPA frame shall only address to the responding AP (i.e., AP2) and the non-AP STA(s) associated with the initiating AP (i.e., AP1).

The UHR NDPA frame is followed after a Short Interframe Space (SIFS) by an EHT sounding NDP(s) from the responding AP(s) (i.e., AP2). The EHT sounding NDP(s) shall be followed after a SIFS by the BFRP Trigger frame from the initiating AP (i.e., AP1). STA1 associated with AP1 shall measure the EHT sounding NDP transmitted by the responding AP(s) (i.e., AP2), and transmit CSI of the channel between the STA1 and AP2 to AP2 in a to-be-determined (TBD) compressed beamforming/CQI frame. Subsequent BFRP Trigger frames, if any, in the cross-BSS UHR TB sounding sequence shall be transmitted a SIFS after the TBD compressed beamforming/CQI frame transmitted in response to the previous BFRP Trigger frame. Each UHR CBF beamformee that is addressed by a BFRP Trigger frame shall respond after a SIFS with an EHT compressed beamforming/CQI frame.

To collect the channel state to compute a steering matrix for DL CBF transmission, both APs need to initiate an EHT TB sounding sequence and a cross-BSS UHR TB sounding sequence sequentially, i.e., total four sounding sequences. For all the sounding sequences, one AP conducts the frequency correction on its EHT sounding NDPs to a TBD range of the reference AP, which may be either AP1 or AP2.

In other words, in sequential sounding, non-AP STAs are sounded separately. APs transmit their NDPs sequentially and each non-AP STA sends its CSI to the relevant AP sequentially. For example, in the scenario of FIG. 1F where STA1 is associated with AP1 and not associated with AP2, upon receiving a first BFRP trigger frames from AP1, STA1 sends H11 to AP1 via an EHT Compressed Beamforming/CQI frame; then upon receiving a second BFRP trigger frames from AP2, STA1 sends H21 to AP2 via a TBD Compressed Beamforming/CQI frame. Likewise, in the scenario of FIG. 1F where STA2 is associated with AP2 and not associated with AP1, upon receiving a first BFRP trigger frame from AP2, STA2 sends H22 to AP2 via an EHT Compressed Beamforming/CQI frame; then upon receiving a second BFRP trigger frames from AP2, STA2 sends H12 to AP1 via a TBD Compressed Beamforming/CQI frame.

FIG. 1H illustrates an example of a joint sounding process. In the example in FIG. 1H, only one non-AP STA associated with AP1 is shown for simplicity. More non-AP STAs associated with AP1 are also possible.

In the UHR TB joint sounding initiated by AP1, AP1 shall transmit the UHR NDPA frame followed after a SIFS by EHT sounding NDPs transmitted simultaneously from the initiating AP (i.e., AP1) and responding AP(s) (i.e., AP2). The UHR NDPA frame shall only address to the responding AP (i.e., AP2) and the non-AP STA(s) associated with the initiating AP (i.e., AP1). STA1 associated with AP1 shall measure the EHT sounding NDPs transmitted by the initiating AP (i.e., AP1) and responding AP(s) (i.e., AP2), and transmit CSIs of channels between the STA1 and AP1 and between STA1 and AP2 to both AP1 and AP2 in a TBD compressed beamforming/CQI frame.

To collect the channel state to compute a steering matrix for DL CBF transmission, both APs need to initiate a UHR TB joint NDP sounding sequentially, i.e., total two sequences. For both UHR TB joint NDP sounding sequences, one AP conducts the frequency correction on its EHT sounding NDPs to a TBD range of the reference AP, which may be either AP1 or AP2.

In other words, in joint sounding, APs transmit their NDPs concurrently and listen for each non-AP STA's CSI frame concurrently. For example, in the scenario of FIG. 1F where STA1 is associated with AP1 and not associated with AP2, AP1 and AP2 transmit an NDP to STA1 at the same time in the joint sounding initiated by AP1. Then, upon receiving a BFRP trigger frame from AP1, STA1 sends H11 and H21 to both AP1 and AP2 via a TBD Compressed Beamforming/CQI frame. Likewise, in the scenario of FIG. 1F where STA2 is associated with AP2 and not associated with AP1, AP1 and AP2 transmit an NDP to STA2 at the same time in the joint sounding initiated by AP2. Upon receiving a BFRP trigger frame from AP2, STA2 sends H12 and H22 to both AP1 and AP2 via a TBD Compressed Beamforming/CQI frame.

Regardless of whether sequential sounding or joint sounding is employed, in the end, AP1 will obtain H11 and H12, and AP2 will obtain H21 and H22. In this way, both AP1 and AP2 can perform CBF (i.e. transmitting towards their own users while avoiding interference towards non-AP STAs associated with the other AP).

in Joint Sounding for CBF, a non-AP STA needs to send a large CSI to multiple APs. In other words, the non-AP STA estimates multiple CSIs of multiple channels between the non-AP STA and multiple APs and transmits the multiple CSI estimates to the multiple APs.

FIG. 1I illustrates an example of delivery of large CSI from a single non-AP STA to multiple APs in a joint sounding process in the scenario as shown FIG. 1F associated with some embodiments of the present disclosure. There are two APs (i.e., AP1 and AP2) and two non-AP STAs (i.e., STA1 and STA2). A large CSI including H11 and H21 may be sent from STA1 to both AP1 and AP2 (e.g., in the TBD Compressed Beamforming/CQI 1 frame as shown in FIG. 1H). Similarly, another large CSI including H12 and H22 may be sent from STA2 to both AP1 and AP2. However, as described with reference to FIG. 1B and FIG. 1C, in current Wi-Fi standards, CSI is sent from a single non-AP STA to a single AP.

In a first aspect, if a non-AP STA attempts to send a large CSI to multiple APs, it cannot construct a single frame (e.g., an EHT Compressed Beamforming/CQI frame) targeting multiple APs simultaneously. This limitation arises from the constraints of the address fields in management frames (e.g., EHT Compressed Beamforming/CQI frames), which restricts the ability to target multiple APs at once. This limitation of STA1 in constructing a single EHT Compressed Beamforming/CQI frame targeting multiple APs is illustrated in FIG. 1J.

FIG. 1J illustrates an example assumption of an EHT Compressed Beamforming/CQI frame carrying a large CSI. For example, STA1 is associated with AP1 and is not associated with AP2. If STA1 needs to send the large CSI to both AP1 and AP2, since the frame originates from STA1 associated with AP1, the address fields of the frame are defined as follows: Address 1=AP1's MAC address, Address 2=STA1's MAC address, and Address 3=AP1's MAC address. As a result, the frame cannot be received by AP2 because only AP1's identifier is included and the frame lacks any identifier or address information for AP2.

In a second aspect, a non-AP STA can generate multiple separate EHT Compressed Beamforming/CQI frames, each targeted at a specific AP. FIG. 1K illustrates an example assumption of two EHT Compressed Beamforming/CQI frames each targeted at a specific AP. As shown in FIG. 1K, STA1 sends H11 to AP1 via an EHT Compressed Beamforming/CQI frame 1 and sends H21 to AP2 via an EHT Compressed Beamforming/CQI frame 2. Compared with the delivery of a large CSI targeting multiple APs, this approach results in increased overhead due to the use of separate frames for each AP.

In view of the above, there is a need for enhancements on CSI delivery. It should be understood that although the need for enhancements on CSI delivery is illustrated in the scenario of CBF, the scope of the present disclosure is not limited in this regard. Embodiments of the present disclosure may also apply to other scenarios of CSI delivery.

Some embodiments of the present disclosure provide solutions for delivery of large CSI. In some embodiments, a non-AP STA may transmit, to multiple APs, a frame containing information indicative of respective CSIs of multiple channels between the non-AP STA and the multiple APs. The frame may further contain identifier information associated with the multiple APs, thus the frame may be designed to target multiple APs. In this way, the transmission overhead for CSI delivery may be reduced. Alternatively, a non-AP STA may transmit, to a first AP that the non-AP STA is associated with, a first frame containing information indicative of respective CSIs of multiple channels between the non-AP STA and multiple APs. Then, the first AP may transmit, to remaining AP(s) among the multiple APs, respective CSI(s) of respective channel(s) between the non-AP STA and the remaining AP(s). Thus, the first AP may receive a large CSI frame from the non-AP STA associated with the first AP, and a second AP that the non-AP STA is not associated with may obtain the CSI of the channel between the non-AP STA and the second AP from the first AP. In this way, the security for CSI delivery may be improved. In some embodiments, the non-AP STA may receive a trigger frame containing identifier information associated with the multiple APs before transmitting the large CSI frame.

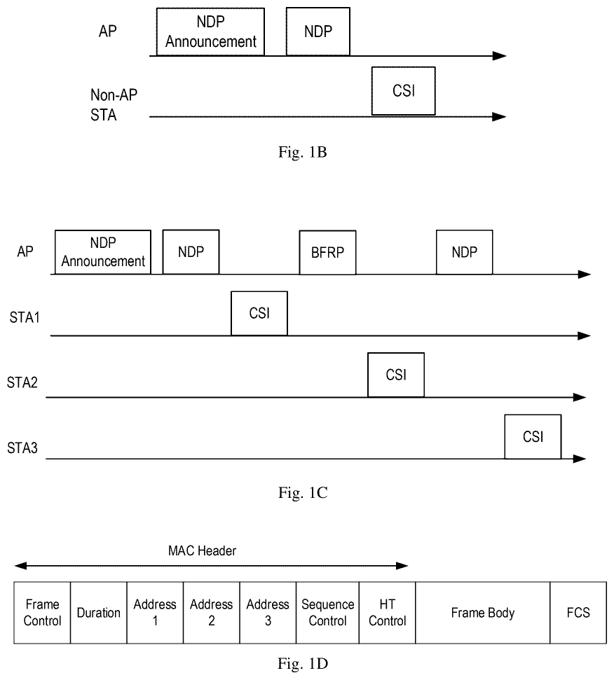

Reference is now made to FIG. 2A, which shows a process 200A for CSI delivery according to an embodiment of the present disclosure. The process 200A may involve non-AP STA 211 and multiple AP devices 221, . . . , 22N. In some implementations, the multiple AP devices 221, . . . , 22N may include only two AP devices 221 and 222. Alternatively, the multiple AP devices 221, . . . , 22N may include more than two AP devices 221, 222, . . . , 22N. The process 200A may be implemented in the communication system 100 in FIG. 1A or other communication systems. For example, the non-AP STA 211 may be implemented as one of the non-AP STA(s) 111 as illustrated in FIG. 1A, and the multiple AP devices 221, . . . , 22N may be implemented as AP 121, AP 122 and other AP(s) not shown in communication system 100 as illustrated in FIG. 1A.

In the process 200A, each of the multiple AP devices 221, . . . , 22N transmits a respective sounding sequence to the non-AP STA 211. The non-AP STA 211 receives multiple sounding sequences from multiple AP devices 221, . . . , 22N. For example, the first AP device 221 transmits (201) a sounding sequence 202 to the non-AP STA 211, and the second AP device 222 transmits (204) a sounding sequence 205 to the non-AP STA 211. In some implementations, the process 200A may involve more than two AP devices, and the Nth AP device 222 may transmit (207) a sounding sequence 208 to the non-AP STA 211. The non-AP STA 211 receives (203) the sounding sequence 202 from the first AP device 221, receives (206) the sounding sequence 205 from the second AP device 222, . . . , and receives (209) the sounding sequence 208 from the Nth AP device 22N. In some embodiments, the multiple sounding sequences may be transmitted simultaneously. The non-AP STA 211 determines (210) respective CSIs of multiple channels between the non-AP STA 211 and the multiple AP devices 221, . . . , 22N based on the multiple sounding sequences. The non-AP STA 211 transmits (212) a frame 213 to the multiple AP devices 221, . . . , 22N. The frame 213 includes information indicative of the respective CSIs of the multiple channels and identifier information associated with the multiple AP devices 221, . . . , 22N. Accordingly, the multiple AP devices 221, . . . , 22N receives the frame 213 from the non-AP STA 211. For example, the first AP device 221 receives (214) the frame 213 from the non-AP STA 211, and the second AP device 222 receives (215) the frame 213 from the non-AP STA 211. In some implementations, the process 200A may involve more than two AP devices, and the Nth AP device 22N receives (216) the frame 213 from the non-AP STA 211. In this way, the non-AP STA 211 may transmit a single frame for CSI transmission to the multiple AP devices 221, . . . , 22N simultaneously. The resource overhead for CSI delivery may thus be reduced.

In some embodiments, the identifier information may include a multicast address associated with the multiple AP devices 221, . . . , 22N. Alternatively or additionally, the identifier information may include identifiers of AP devices of the multiple AP devices 221, . . . , 22N. The frame 213 may be received by the multiple AP devices 221, . . . , 22N by containing the multicast address associated with the multiple AP devices 221, . . . , 22N or the AP device identifiers of the multiple AP devices 221, . . . , 22N.

In some implementations, the non-AP STA 211 is associated with the first AP device 221 among the multiple AP devices 221, . . . , 22N. An identifier of the first AP device 221 may include an AP MAC address of the first AP device 221. Alternatively or additionally, an identifier of the first AP device 221 may include an AP identity (ID) of the first AP device 221.

In some implementations, the non-AP STA 211 is not associated with at least an AP device 222, . . . , 22N among the multiple AP devices 221, . . . , 22N. An identifier of an AP device of the at least an AP device 222, . . . , 22N may include an AP MAC address of the AP device. Alternatively or additionally, an identifier of a AP device of the at least an AP device 222, . . . , 22N may include an AP ID of the AP device. For example, the non-AP STA 211 is not associated with the second AP device 222, and an identifier of the second AP device 222 may include at least one of an AP MAC address, an AP ID or any other identifier of the second AP device 222.

In some embodiments, the multicast address associated with the multiple AP devices 221, . . . , 22N may be carried in the address 1 field of the frame 213. Alternatively or additionally, the multicast address associated with the multiple AP devices 221, . . . , 22N may be carried in the address 3 field of the frame 213. Alternatively or additionally, the multicast address associated with the multiple AP devices 221, . . . , 22N may be carried in a frame body field of the frame 213. In this way, if an AP device receives a frame carrying a multicast address associated with a group of AP devices including the AP device in address 1 field/address 3 field/frame body, the AP device may be aware that the frame is targeted to it and the CSI information carried in the frame may thus be obtained by the AP device.

In some implementations, the non-AP STA 211 may be associated with the first AP device 221 among the multiple AP devices 221, . . . , 22N. The address 1 field of the frame 213 may carry a broadcast address, the address 3 field of the frame 213 may carry an identifier of the first AP device 221, and the frame body field of the frame 213 may carry a multicast address associated with the multiple AP devices 221, . . . , 22N.

In some implementations, the non-AP STA 211 may be associated with the first AP device 221 among the multiple AP devices 221, . . . , 22N. The address 1 field of the frame 213 may carry a broadcast address, the address 3 field of the frame 213 may carry a broadcast address, and the frame body field of the frame 213 may carry a multicast address associated with the multiple AP devices 221, . . . , 22N.

In some implementations, the address 1 field of the frame 213 may carry a broadcast address, and the address 3 field of the frame 213 may carry a multicast address associated with the multiple AP devices 221, . . . , 22N.

In some implementations, the non-AP STA 211 is associated with the first AP device 221 among the multiple AP devices 221, . . . , 22N. The address 1 field of the frame 213 may carry a multicast address associated with the multiple AP devices 221, . . . , 22N, and the address 3 field of the frame 213 may carry an identifier of the first AP device 221.

In some implementations, the non-AP STA 211 is associated with the first AP device 221 among the multiple AP devices 221, . . . , 22N. The address 1 field of the frame 213 may carry a multicast address associated with the multiple AP devices 221, . . . , 22N, and the address 3 field of the frame 213 may carry a broadcast address, or

In some implementations, the non-AP STA 211 is associated with the first AP device 221 among the multiple AP devices 221, . . . , 22N. The address 1 field of the frame 213 may carry a multicast address associated with the multiple AP devices 221, . . . , 22N, and the address 3 field of the frame 213 may carry a multicast address associated with the multiple AP devices 221, . . . , 22N.

In some implementations, the non-AP STA 211 is associated with the first AP device 221 among the multiple AP devices 221, . . . , 22N. The address 1 field of the frame 213 may carry an identifier of the first AP device 221, and the address 3 field of the frame 213 may carry a multicast address associated with the multiple AP devices 221, . . . , 22N.

In some embodiments, the identifiers of the AP devices of the multiple AP devices 221, . . . , 22N may be carried in the frame body field of the frame 213. The address 1 field of the frame 213 may carry a broadcast address. The address 3 field of the frame 213 may carry a broadcast address.

In some embodiments, the non-AP STA 211 is associated with the first AP device 221 among the multiple AP devices 221, . . . , 22N and not associated with the at least an AP device 222, . . . , 22N. An identifier of the first AP device 221 is carried in at least one of the address 1 field or the address 3 field of the frame 213. At least an identifier of the at least an AP device 222, . . . , 22N is carried in a frame body field of the frame 213. In some implementations, the identifier of the first AP device 221 is carried in both the address 1 field and the address 3 field of the frame 213. Alternatively, the identifier of the first AP device 221 is carried in the address 3 field of the frame 213, and the address 1 field of the frame 213 may carry a broadcast address.

In some embodiments, the multiple AP devices 221, . . . , 22N may include the first AP device 221 and the second AP device 222. The non-AP STA 211 is associated with the first AP device 221 and not associated with the second AP device 222. The address 1 field of the frame 213 may carry an identifier of the first AP device 221, and the address 3 field of the frame 213 may carry an identifier of the second AP device 222. In other words, the frame 213 may be transmitted to two AP devices, and carry the identifier of one among the two AP devices that the non-AP STA 211 is not associated with in the address 2 field.

In this way, a frame format of a frame to be transmitted to multiple AP devices may be designed. By carrying CSIs of multiple channels associated with multiple AP devices in a single frame, the resource overhead for CSI delivery may thus be reduced.

FIG. 2B shows another process 200B for CSI delivery according to an embodiment of the present disclosure. The process 200B may involve non-AP STA 211 and multiple AP devices 221, . . . , 22N. In some implementations, the multiple AP devices 221, . . . , 22N may include only two AP devices 221 and 222. Alternatively, the multiple AP devices 221, . . . , 22N may include more than two AP devices 221, 222, . . . , 22N. The process 200B may be implemented in the communication system 100 in FIG. 1A or other communication systems. For example, the non-AP STA 211 may be implemented as one of the non-AP STA(s) 111 as illustrated in FIG. 1A, and the multiple AP devices 221, . . . , 22N may be implemented as AP 121, AP 122 and other AP(s) not shown in communication system 100 as illustrated in FIG. 1A. The same reference numerals are used to denote the elements or components described in FIG. 2B having the same operations as the elements or components described in FIG. 2A, and detailed description thereof will be omitted.

In the process 200B, each of the multiple AP devices 221, . . . , 22N transmits a respective sounding sequence to the non-AP STA 211. The non-AP STA 211 receives multiple sounding sequences from multiple AP devices 221, . . . , 22N. In some embodiments, the multiple sounding sequences may be transmitted simultaneously. The non-AP STA 211 determines (210) respective CSIs of multiple channels between the non-AP STA 211 and the multiple AP devices 221, . . . , 22N based on the multiple sounding sequences. The non-AP STA 211 transmits (231) a first frame 232 to the first AP device 221 among the multiple AP devices 221, . . . , 22N. The first frame 232 includes information indicative of the respective CSIs of the multiple channels. The first AP device 221 receives (233) the first frame 232 from the non-AP STA 211, and transmits, to the at least an AP device 222, . . . , 22N, at least a CSI of at least a channel between the non-AP STA 211 and the at least an AP device 222, . . . , 22N. In this way, the non-AP STA 211 may transmit a single frame carrying CSI associated with multiple AP devices to the first AP device 221, and the first AP device 221 may forward the CSI to other AP devices. The power consumption of the non-AP STA may be reduced for the CSI delivery and the security for CSI delivery may be improved.

In some embodiments, the first frame 232 may further include first identifier information associated with the multiple AP devices 221, . . . , 22N.

In some implementations, the first identifier information may include at least an identifier of the at least an AP device 222, . . . , 22N. Alternatively, the first identifier information may include identifiers of AP devices of the multiple AP devices 221, . . . , 22N. Alternatively, the first identifier information may include a multicast address associated with the multiple AP devices 221, . . . , 22N.

In some implementations, an identifier of the first AP device 221 may include an AP MAC address of the first AP device 221. Alternatively or additionally, an identifier of the first AP device 221 may include an AP ID of the first AP device 221.

In some implementations, an identifier of an AP device of the at least an AP device 222, . . . , 22N may include an AP MAC address of the AP device. Alternatively or additionally, an identifier of a AP device of the at least an AP device 222, . . . , 22N may include an AP ID of the AP device. For example, the non-AP STA 211 is not associated with the second AP device 222, and an identifier of the second AP device 222 may include at least one of an AP MAC address, an AP ID or any other identifier of the second AP device 222.

In some embodiments, the first identifier information is carried in a frame body field of the first frame 232. In some embodiments, the non-AP STA 211 is associated with the first AP device 221 and not associated with the at least an AP device 222, . . . , 22N. In other words, the non-AP STA may transmit a single frame carrying CSI associated with multiple AP devices to the AP device that the non-AP STA is associated with.

In some embodiments, when transmitting the at least a CSI of the at least a channel, the first AP device 221 may transmit, to an AP device of the at least an AP device 222, . . . , 22N, a second frame comprising information indicative of a CSI of a channel between the non-AP STA 211 and the AP device. In other words, the first AP device 221 may transmit respective CSI of a respective channel to a respective one of the at least an AP device 222, . . . , 22N. For example, the first AP device 221 may transmit (234) CSI 235 of a channel between the non-AP STA 211 and the second AP device 222 to the second AP device 222, and the second AP device 222 may receive (236) the CSI 235 of the channel between the non-AP STA 211 and the second AP device 222 from the first AP device 221. In some implementations, the process 200A may involve more than two AP devices. The first AP device 221 may transmit (237) CSI 238 of a channel between the non-AP STA 211 and the Nth AP device 22N to the second AP device 222, and the Nth AP device 22N may receive (239) the CSI 238 of the channel between the non-AP STA 211 and the Nth AP device 22N from the first AP device 221. The CSI 235 and the CSI 238 may be transmitted to the second AP device 222 and the Nth AP device 22N, respectively. In some example implementations, the CSI 235 and the CSI 238 may be transmitted to the second AP device 222 and the Nth AP device 22N simultaneously or at different time instances.

The frame format of the second frame transmitted from the first AP device 221 to the AP device of the at least an AP device 222, . . . , 22N may be designed. In some implementations, an address 2 field of the second frame may carry an identifier of the first AP device 221. In some implementations, an address 1 field of the second frame may carry an identifier of the AP device, and an address 3 field of the second frame may carry an identifier of the first AP device 221. Alternatively, an address 1 field of the second frame may carry an identifier of the AP device, and an address 3 field of the second frame may carry an identifier of the AP device. Alternatively, an address 1 field of the second frame may carry an identifier of the AP device, and an address 3 field of the second frame may carry a broadcast address.

In some embodiments, when transmitting the at least a CSI of the at least a channel, the first AP device 221 may transmit, to the at least an AP device 222, . . . , 22N, a second frame comprising information indicative of the at least a CSI of the at least a channel. In other words, the first AP device 221 may transmit a frame carrying the at least a CSI of the at least a channel to the at least an AP device 222, . . . , 22N. That is, both the CSI 235 and the CSI 238 may be carried in a single frame targeting to both the second AP device 222 and the Nth AP device 22N.

In some implementations, the second frame may further include second identifier information associated with the at least an AP device 222, . . . , 22N. The second identifier information may include at least an identifier of the at least an AP device 222, . . . , 22N. Alternatively or additionally, the second identifier information may include a multicast address associated with the multiple AP devices 221, . . . , 22N.

The frame format of the second frame transmitted from the first AP device 221 to the at least an AP device 222, . . . , 22N may be designed. In some implementations, an address 2 field of the second frame may carry an identifier of the first AP device 221. In some implementations, an address 1 field of the second frame may carry a broadcast address, an address 3 field of the second frame may carry an identifier of the first AP device 221, and a frame body field of the second frame may carry at least an identifier of the at least an AP device 222, . . . , 22N. Alternatively, an address 1 field of the second frame may carry a broadcast address, an address 3 field of the second frame may carry a broadcast address, and a frame body field of the second frame may carry at least an identifier of the at least an AP device 222, . . . , 22N. Alternatively, an address 1 field of the second frame may carry a multicast address associated with the multiple AP devices 221, . . . , 22N, and an address 3 field of the second frame may carry an identifier of the first AP device 221. Alternatively, an address 1 field of the second frame may carry a multicast address associated with the multiple AP devices 221, . . . , 22N, and an address 3 field of the second frame may carry a broadcast address.

In some embodiments, the first AP device 221 may determine that the non-AP STA 211 roams from the first AP device 221 to an AP device (e.g., the second AP device 222) among the at least an AP device 222, . . . , 22N. Based on determining that the non-AP STA 211 roams from the first AP device 221 to the second AP device 222, the first AP device 221 may transmit a CSI of a channel between the non-AP STA 211 and the second AP device 222 to the second AP device 222. For example, the CSI of the channel between the non-AP STA 211 and the second AP device is carried in a context transfer message. In some implementations, the first AP device 221 may also transmit a CSI of a channel between the non-AP STA 211 and the first AP device 221 to the second AP device 222.

FIG. 2C shows a process 200C of triggering of CSI delivery according to an embodiment of the present disclosure. The process 200C may involve non-AP STA 211 and multiple AP devices 221, . . . , 22N. In some implementations, the multiple AP devices 221, . . . , 22N may include only two AP devices 221 and 222. Alternatively, the multiple AP devices 221, . . . , 22N may include more than two AP devices 221, 222, . . . , 22N. The process 200C may be implemented in the communication system 100 in FIG. 1A or other communication systems. For example, the non-AP STA 211 may be implemented as one of the non-AP STA(s) 111 as illustrated in FIG. 1A, and the multiple AP devices 221, . . . , 22N may be implemented as AP 121, AP 122 and other AP(s) not shown in communication system 100 as illustrated in FIG. 1A. The same reference numerals are used to denote the elements or components described in FIG. 2C having the same operations as the elements or components described in FIGS. 2A and 2B, and detailed description thereof will be omitted. Embodiments of the process 200C may be implemented dependently from the processes 200A and 200B in FIGS. 2A and 2B. Alternatively, embodiments of the process 200C may be implemented dependently from the process 200A in FIG. 2A or the process 200B in FIG. 2B.

In the process 200C, each of the multiple AP devices 221, . . . , 22N transmits a respective sounding sequence to the non-AP STA 211. The non-AP STA 211 receives multiple sounding sequences from multiple AP devices 221, . . . , 22N. In some embodiments, the multiple sounding sequences may be transmitted simultaneously. The first AP device 221 among the multiple AP devices 221, . . . , 22N transmits (217) a trigger frame 218 to the non-AP STA 211. The trigger frame 218 includes identifier information associated with the multiple AP devices 221, . . . , 22N. The non-AP STA 211 receives (219) the trigger frame 218 carrying identifier information associated with the multiple AP devices 221, . . . , 22N from the first AP device 221, and transmits (241) a frame 242 comprising information indicative of respective CSIs of a plurality of channels between the non-AP STA 211 and the multiple AP devices 221, . . . , 22N. In some implementations, the frame 242 may be transmitted to the multiple AP devices 221, . . . , 22N. For example, the frame 242 may be implemented as the frame 213 in FIG. 2A. In some implementations, the frame 242 may be transmitted to the first AP device 221. For example, the frame 242 may be implemented as the frame 232 in FIG. 2B. Other format designs for the frame 242 are also possible.

In some embodiments, the trigger frame 218 may include a transmitter address field carrying the identifier of the first AP device 221 and a user information list field carrying the identifier information.

In some embodiments, the identifier information may include at least an identifier of the at least an AP device 222, . . . , 22N. Alternatively, the identifier information may include identifiers of AP devices of the multiple AP devices 221, . . . , 22N. Alternatively, the identifier information may include a multicast address associated with the multiple AP devices 221, . . . , 22N.

In some implementations, an identifier of the first AP device 221 may include an AP MAC address of the first AP device 221. Alternatively or additionally, an identifier of the first AP device 221 may include an AP ID of the first AP device 221.

In some implementations, an identifier of an AP device of the at least an AP device 222, . . . , 22N may include an AP MAC address of the AP device. Alternatively or additionally, an identifier of a AP device of the at least an AP device 222, . . . , 22N may include an AP ID of the AP device. For example, the non-AP STA 211 is not associated with the second AP device 222, and an identifier of the second AP device 222 may include at least one of an AP MAC address, an AP ID or any other identifier of the second AP device 222.

In some embodiments, the non-AP STA 211 is associated with the first AP device 221 and not associated with the at least an AP device 222, . . . , 22N. The trigger frame 218 may be a BFRP frame.

Embodiments of the present disclosure provide various options for CSI frame's format, which are equally applicable to all management/action frames, specifically the ones shown in Table 1 (e.g. EHT Compressed Beamforming/CQI frame for 802.11be/Wi-Fi 7, UHR Compressed Beamforming/CQI frame for 802.11bn/Wi-Fi 8 etc.).

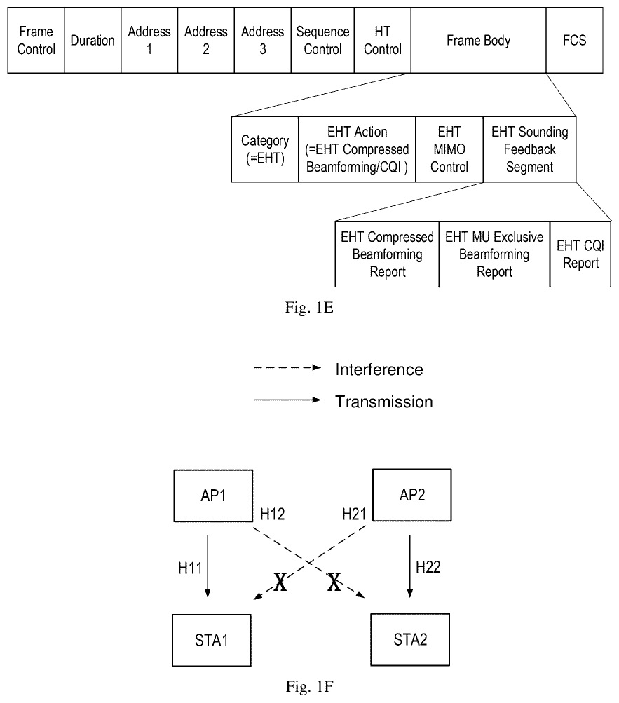

FIG. 3 illustrates an example of CSI delivery in a joint sounding process according to some embodiments of the present disclosure. For the purpose of discussion, FIG. 3 will be described with reference to FIG. 1F. STA1 may be associated with AP1 and not associated with AP2. STA2 may be associated with AP2 and not associated with AP1. The communication channel between AP1 and STA1 corresponds to H11. The communication channel between AP2 and STA2 corresponds to H22. The interference channel between AP1 and STA2 corresponds to H12. The interference channel between AP2 and STA1 corresponds to H21.

As shown in FIG. 3, upon receiving BFRP, STA1 may send a single CSI frame containing the combined CSI information (H11+H21), and the single CSI frame is transmitted in such a way that it is simultaneously received by both AP1 and AP2. Similarly, upon receiving BFRP, STA2 may send a single CSI frame containing the combined CSI information (H12+H22), and the single CSI frame is transmitted in such a way that it is simultaneously received by both AP1 and AP2. AP1 may perform CBF operation based on the H11 carried in the CSI frame from STA1 and the H12 carried in the CSI frame from STA2. AP2 may perform CBF operation based on the H21 carried in the CSI frame from STA1 and the H22 carried in the CSI frame from STA2.

In this way, only a single CSI frame is used for the CSI delivery to multiple APs. The overall transmission overhead is reduced, thus improving the overhead efficiency. It would be understood that there may be extra APs (e.g. AP3, not shown) in some implementations. The interference channel between AP3 and STA1 may correspond to H31. The interference channel between AP3 and STA2 may correspond to H32. The single CSI frame transmitted by STA1 may contain the combined CSI information (H11+H21+H31). The single CSI frame transmitted by STA2 may contain the combined CSI information (H11+H21+H32).

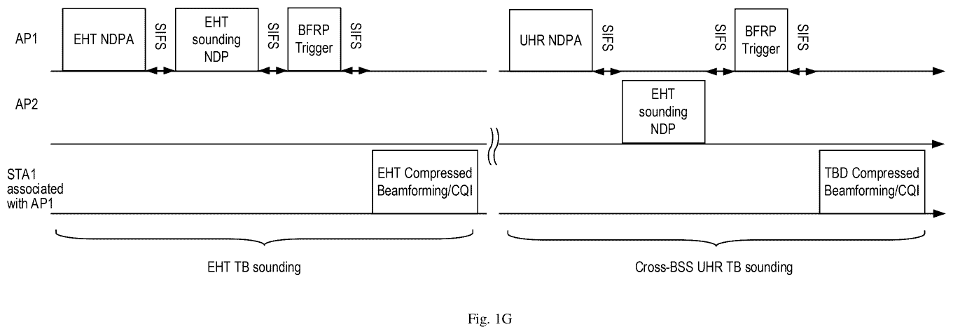

Some specific examples of the frame format of the single CSI frame transmitted by STA1 are shown in FIGS. 4A to 4H. In the following options, the AP1 identifier may be AP1's MAC Address, AP1's ID, or any other identifier of AP1, the AP2 identifier may be AP2's MAC Address, AP2's ID, or any other identifier of AP2, the STA1 identifier may be AID of STA1, STA1's MAC Address, or any other identifier of STA1. FF may represent a broadcast address that may be received by all receivers. For example, if a MAC address is used, the broadcast address might be FF:FF:FF:FF:FF:FF. XX may represent a multicast address that is intended for a specific group of receivers. For instance, if AP1's MAC address is AA:BB:CC:DD:EE:FF and AP2's MAC address is GG:HH:II:JJ:KK:LL, the multicast address XX is mapped to these two MAC addresses. When AP1 and AP2 receive XX, AP1 and AP2 may determine that they are the intended recipients.

FIG. 4A illustrates a first example of a single CSI frame transmitted from STA1 to multiple AP devices in the process shown in FIG. 3 according to some embodiments of the present disclosure. As shown in FIG. 4A, Address 1 of the CSI frame may be set to FF so that it can be received by all receivers. STA1 may send this frame, therefore Address 2 may be set to STA1 identifier. Address 3 of the CSI frame may be set to AP1 identifier or FF. Frame body of the CSI frame may carry XX identifier. This makes sure that both AP1 and AP2 receive this frame. Additionally, any extra APs (e.g., AP3) involved in the CBF operation can be included here in the same manner. Furthermore, Frame body of the CSI frame may further carry the combined CSI (H11+H21) (including CSI of extra APs (e.g., AP3 CSI), if any).

FIG. 4B illustrates a second example of a single CSI frame transmitted from STA1 to multiple AP devices in the process shown in FIG. 3 according to some embodiments of the present disclosure. As shown in FIG. 4B, Address 1 of the CSI frame may be set to FF so that it can be received by all receivers. STA1 may send this frame, therefore Address 2 of the CSI frame may be set to STA1 identifier. Address 3 of the CSI frame may be set to XX. This field makes sure that both AP1 and AP2 receive this frame. Additionally, any extra APs (e.g., AP3) involved in the CBF operation can be included here in the same manner. Furthermore, Frame body of the CSI frame may carry the combined CSI (H11+H21) (including CSI of extra APs (e.g., AP3 CSI), if any).

FIG. 4C illustrates a third example of a single CSI frame transmitted from STA1 to multiple AP devices in the process shown in FIG. 3 according to some embodiments of the present disclosure. As shown in FIG. 4C, Address 1 of the CSI frame may be set to XX. This field makes sure that BOTH AP1 AND AP2 receive this frame. Additionally, any extra APs (e.g., AP3) involved in the CBF operation can be included here in the same manner. STA1 may send this frame, therefore Address 2 of the CSI frame may be set to STA1 identifier. Address 3 of the CSI frame may be set to XX. Frame body of the CSI frame may carry the combined CSI (H11+H21) (including CSI of extra APs (e.g., AP3 CSI), if any).

FIG. 4D illustrates a fourth example of a single CSI frame transmitted from STA1 to multiple AP devices in the process shown in FIG. 3 according to some embodiments of the present disclosure. As shown in FIG. 4D, Address 1 of the CSI frame may be set to AP1 identifier. This field makes sure that AP1 receives this frame. STA1 may send this frame, therefore Address 2 of the CSI frame may be set to STA1 identifier. Address 3 of the CSI frame may be set to AP1 identifier. Frame body of the CSI frame may carry AP2 identifier. This field makes sure that AP2 receives this frame. Additionally, any extra APs (e.g., AP3) involved in the CBF operation can be included here in the same manner. Frame body of the CSI frame may further carry the combined CSI (H11+H21) (including CSI of extra APs (e.g., AP3 CSI), if any).

FIG. 4E illustrates a fifth example of a single CSI frame transmitted from STA1 to multiple AP devices in the process shown in FIG. 3 according to some embodiments of the present disclosure. As shown in FIG. 4E, Address 1 of the CSI frame may be set to FF. STA1 may send this frame, therefore Address 2 of the CSI frame may be set to STA1 identifier. Address 3 may be set to FF. Frame body of the CSI frame may carry AP1 identifier and AP2 identifier. This field makes sure that AP1 and AP2 receive this frame. Additionally, any extra APs (e.g., AP3) involved in the CBF operation can be included here in the same manner. Frame body of the CSI frame may further carry the combined CSI (H11+H21) (including CSI of extra APs (e.g., AP3 CSI), if any).

FIG. 4F illustrates a sixth example of a single CSI frame transmitted from STA1 to multiple AP devices in the process shown in FIG. 3 according to some embodiments of the present disclosure. As shown in FIG. 4F, Address 1 of the CSI frame may be set to FF. STA1 may send this frame, therefore Address 2 of the CSI frame may be set to STA1 identifier. Address 3 of the CSI frame may be set to AP1 identifier. This field makes sure that AP1 receives this frame. Frame body of the CSI frame may carry AP2 identifier. This field makes sure that AP2 receives this frame. Additionally, any extra APs (e.g., AP3) involved in the CBF operation can be included here in the same manner. Frame body of the CSI frame may further carry the combined CSI (H11+H21) (including CSI of extra APs (e.g., AP3 CSI), if any).

FIG. 4G illustrates a seventh example of a single CSI frame transmitted from STA1 to multiple AP devices in the process shown in FIG. 3 according to some embodiments of the present disclosure. As shown in FIG. 4G, Address 1 of the CSI frame may be set to AP1 identifier. This field makes sure that AP1 receives this frame. STA1 may send this frame, therefore Address 2 of the CSI frame may be set to STA1 identifier. Address 3 of the CSI frame may be set to AP2 identifier. This field makes sure that AP2 receives this frame. However, no extra APs (e.g., AP3) involved in the CBF operation can be included here because Address 3 is limited to a single identifier, meaning it can only represent AP2. Frame body of the CSI frame may carry the combined CSI (H11+H21).

FIG. 4H illustrates an eighth example of a single CSI frame transmitted from STA1 to multiple AP devices in the process shown in FIG. 3 according to some embodiments of the present disclosure. As shown in FIG. 4H, Address 1 of the CSI frame may be set to AP1 identifier. This field makes sure that AP1 receives this frame. STA1 may send this frame, therefore Address 2 of the CSI frame may be set to STA1 identifier. Address 3 of the CSI frame may be set to XX. This field makes sure that both AP1 and AP2 receive this frame. Additionally, any extra APs (e.g., AP3) involved in the CBF operation can be included here in the same manner. Furthermore, Frame body of the CSI frame may carry the combined CSI (H11+H21) (including CSI of extra APs (e.g., AP3 CSI), if any).

With the frame formats in FIGS. 4A to 4H, a single CSI frame is received by AP1 and AP2 simultaneously. It should be understood that the scope of the present disclosure is not limited to these examples, and other frame formats are also possible. If the XX identifier is carried in at least one of Address 1, Address 3 or Frame body of the CSI frame, APs in the group associated with XX may receive this frame. In another example, if Address 1 of the CSI frame carries AP1 identifier, Address 3 of the CSI frame is set to FF, and Frame body of the CSI frame carries AP1 identifier and AP2 identifier and identifiers of any extra APs (e.g., AP3) involved in the CBF operation, AP1, AP2 as well as the extra APs may receive this frame. It should be understood that the frame format design may be equally applicable to the single CSI frame transmitted by other non-AP STAs (e.g., STA2 in FIG. 3).

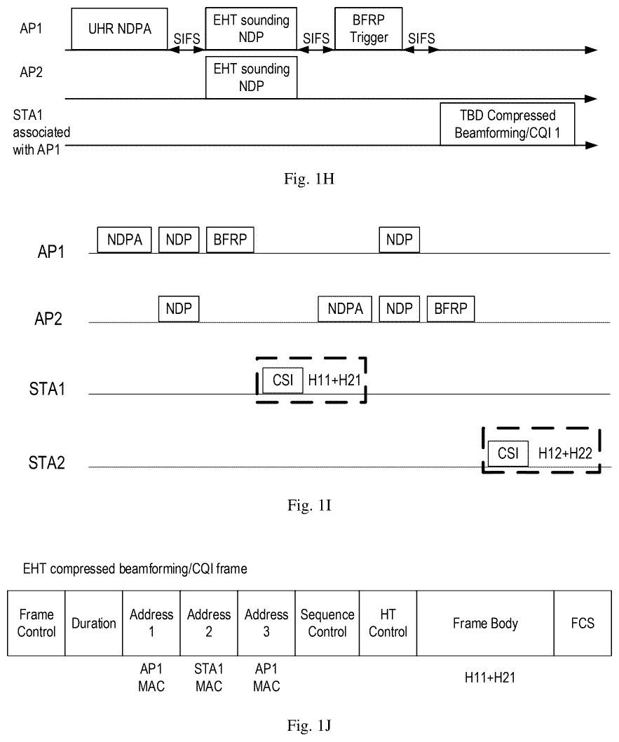

FIG. 5 illustrates another example of CSI delivery in a joint sounding process according to some embodiments of the present disclosure. For the purpose of discussion, FIG. 5 will be described with reference to FIG. 1F. STA1 may be associated with AP1 and not associated with AP2. STA2 may be associated with AP2 and not associated with AP1. The communication channel between AP1 and STA1 corresponds to H11. The communication channel between AP2 and STA2 corresponds to H22. The interference channel between AP1 and STA2 corresponds to H12. The interference channel between AP2 and STA1 corresponds to H21.

As shown in FIG. 5, upon receiving BFRP, STA1 may send a single CSI frame containing the combined CSI information (H11+H21), and the single CSI frame is transmitted in such a way that the single CSI frame is received by AP1, then H21 carried in the single CSI frame is forwarded to AP2. Similarly, upon receiving BFRP, STA2 may send a single CSI frame containing the combined CSI information (H12+H22), and the single CSI frame is transmitted in such a way that the single CSI frame is received by AP2, then H12 carried in the single CSI frame is forwarded to AP1. AP1 may perform CBF operation based on the H11 carried in the CSI frame from STA1 and the H12 received from AP2. AP2 may perform CBF operation based on the H21 received from AP1 and the H22 carried in the CSI frame from STA2.

In this way, STA1 may send a single CSI frame carrying CSIs associated with multiple APs to the AP that STA1 is associated with (i.e., AP1). From a security perspective, this CSI delivery can be protected, as STA1 and AP1 share a secure connection, allowing the large CSI frame to be encrypted between STA1 and AP1. Assuming a secure connection also exists between AP1 and AP2, the CSI associated with AP2 can be safely forwarded from AP1 to AP2. Therefore, stronger security may be enabled. It would be understood that there may be extra APs (e.g. AP3, not shown) in some implementations. The interference channel between AP3 and STA1 may correspond to H31. The interference channel between AP3 and STA2 may correspond to H32. The single CSI frame transmitted from STA1 to AP1 may contain the combined CSI information (H11+H21+H31). AP1 may also forward H31 to AP3. In some options, AP1 may transmit H21+H31 to AP2 and AP3 in a single frame. In other options, AP1 may transmit H21 to AP2 and transmit H31 to AP3 in separate frames.

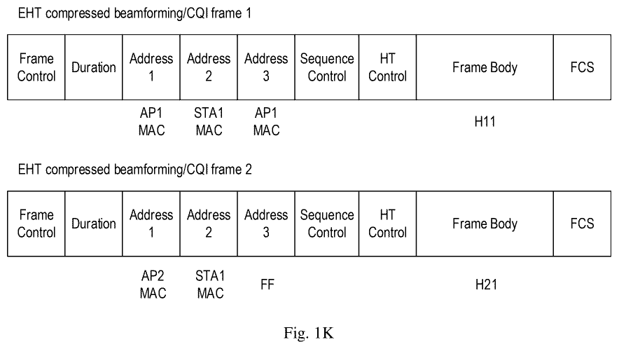

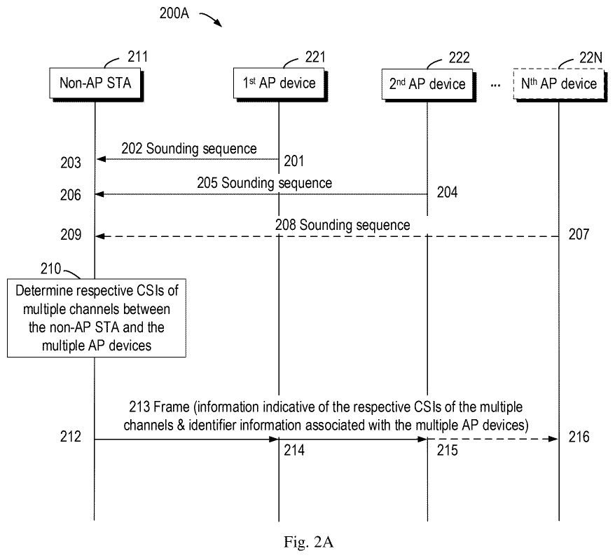

A specific example of the frame format of the single CSI frame transmitted from STA1 to AP1 is shown in FIG. 6. Some specific examples of the frame format of the CSI frame transmitted from AP1 to AP2 (and optionally extra APs) are shown in FIGS. 7A to 7C. In the following options, the AP1 identifier may be AP1's MAC Address, AP1's ID, or any other identifier of AP1, the AP2 identifier may be AP2's MAC Address, AP2's ID, or any other identifier of AP2, the STA1 identifier may be AID of STA1, STA1's MAC Address, or any other identifier of STA1. FF may represent a broadcast address that may be received by all receivers. XX may represent a multicast address that is intended for a specific group of receivers.

FIG. 6 illustrates an example of a single CSI frame transmitted from STA1 to AP1 carrying CSI associated with multiple AP devices in the process shown in FIG. 5 according to some embodiments of the present disclosure. As shown in FIG. 6, Address 1 of the CSI frame may be set to AP1 identifier. This field makes sure that AP1 receives this frame. STA1 may send this frame, therefore Address 2 of the CSI frame may be set to STA1 identifier. Address 3 of the CSI frame may be set to AP1 identifier. Frame body of the CSI frame may carry AP2 identifier. This field makes sure that this frame will be transmitted to AP2. Additionally, any extra APs (e.g., AP3) involved in the CBF operation can be included here in the same manner. Frame body of the CSI frame may further carry the combined CSI (H11+H21) (including CSI of extra APs (e.g., AP3 CSI), if any).

With the frame format in FIG. 6, a single CSI frame carrying CSI associated with multiple AP devices is transmitted from STA1 to AP1, enabling AP1 to forward respective CSI to other AP device(s). It should be understood that the scope of the present disclosure is not limited to these examples, and other frame formats are also possible. For example, if the XX identifier is carried in at least one of Address 3 or Frame body of the CSI frame, AP1 may be aware that CSI associated with APs in the group associated with XX is carried in the frame and may then perform CSI forwarding to other APs.

FIG. 7A illustrates a first example of a CSI frame transmitted from AP1 to other APs involved in the process shown in FIG. 5 according to some embodiments of the present disclosure. As shown in FIG. 7A, Address 1 of the CSI frame may be set to FF. AP1 may send this frame therefore Address 2 of the CSI frame may be set to AP1 identifier. Address 3 of the CSI frame may be set to AP1 identifier or FF. Frame body of the CSI frame may carry AP2 identifier. This makes sure that AP2 receive this frame. Additionally, any extra APs (e.g., AP3) involved in the CBF operation can be included here in the same manner. Frame body of the CSI frame may further carry the CSI for AP2 (H21) (including CSI for extra APs (e.g., AP3), if any).

FIG. 7B illustrates a second example of a CSI frame transmitted from AP1 to other APs involved in the process shown in FIG. 5 according to some embodiments of the present disclosure. As shown in FIG. 7B, Address 1 of the CSI frame may be set to XX. This makes sure that AP2 receive this frame. Additionally, any extra APs (e.g., AP3) involved in the CBF operation can be included here in the same manner. AP1 may send this frame therefore Address 2 of the CSI frame may be set to AP1 identifier. Address 3 can be set AP1 identifier or FF. Frame body of the CSI frame may carry the CSI for AP2 (H21) (including CSI for extra APs (e.g., AP3), if any).

FIG. 7C illustrates a third example of a CSI frame transmitted from AP1 to another AP involved in the process shown in FIG. 5 according to some embodiments of the present disclosure. As shown in FIG. 7C, Address 1 of the CSI frame may be set to AP2 identifier. This field makes sure that AP2 receives this frame. AP1 may send this frame therefore Address 2 of the CSI frame may be set to AP1 identifier. Address 3 of the CSI frame can be set AP1 identifier, AP2 identifier, any extra APs (e.g., AP3), or FF. Frame body of the CSI frame may carry the CSI for AP2 (H21) (or CSI for an extra AP (e.g., AP3)) Similarly, any extra AP (e.g., AP3) involved in the CBF operation can be included in the Address 1 of a CSI frame transmitted from AP1 to the extra AP with the Frame body carrying the CSI for the extra AP (e.g., AP3).

With the frame formats in FIGS. 7A to 7B, a single CSI frame is transmitted from AP1 to AP2 and any extra APs (e.g., AP3) involved in the CBF operation simultaneously. With the frame format in FIG. 7C, a CSI frame is transmitted from AP1 to one AP involved in the CBF operation. It should be understood that the scope of the present disclosure is not limited to these examples, and other frame formats are also possible. For example, if the XX identifier is carried in at least one of Address 1, Address 3 or Frame body of the CSI frame, other APs except AP1 in the group associated with XX may receive this frame.

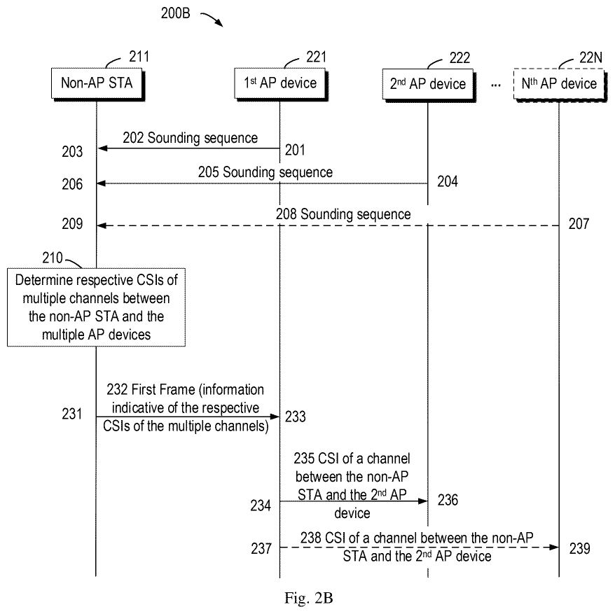

Some embodiments of the present disclosure may be applied to other scenarios besides the scope of CBF. For example, some embodiments of the present disclosure may be applied to roaming scenarios. FIG. 8 illustrates an example of CSI delivery in a roaming scenario according to some embodiments of the present disclosure. Initially, STA1 may be associated with AP1 and not associated with AP2. STA1 may send a single CSI frame containing the combined CSI information (H11+H21). When STA1 roams from AP1 to AP2, AP1 may transfer some information (named as context transfer) regarding STA1 to AP2. In this scenario, CSI=H21 or CSI=H11+H21 can be transferred from AP1 to AP2 as part of the context transfer.

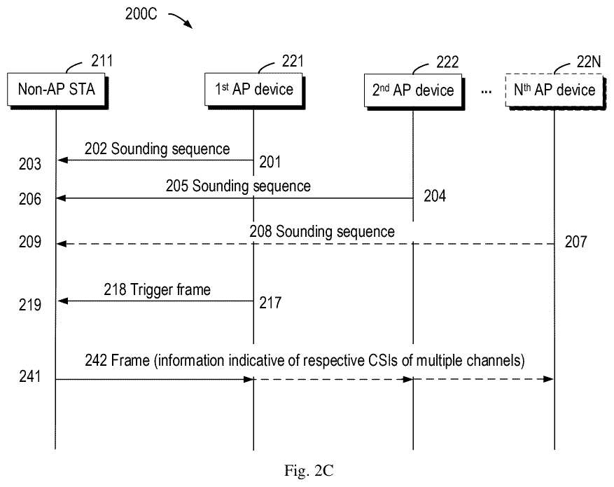

FIG. 9 illustrates an example of a BFRP frame according to some embodiments of the present disclosure. The BFRP frame may be applied in the processes in FIGS. 3, 5 and 8. AP1 may use the BFRP frame to inform STA1 associated with AP1 about the intended receivers (AP1 and AP2) of the subsequent CSI frame. Alternatively, AP1 may use the BFRP frame to inform STA1 associated with AP1 to transmit CSI associated with the corresponding APs. As shown in FIG. 9, AP1 may send this frame, therefore the TA field may be set to AP1 identifier. From this, STA1 understands that the BFRP comes from AP1, and CSI of the channel between STA1 and AP1 should be transmitted to AP1. AP1 may also include AP2 identifier in User Info List in the BFRP frame. This makes sure that STA1 now knows that AP2 needs to know CSI of the channel between STA1 and AP2. Additionally, any extra APs (e.g., AP3) involved in the CBF operation can be included here in the same manner.

With the frame format in FIG. 9, STA1 may be informed to transmit CSI associated with multiple APs. STA1 may transmit a single CSI frame carrying CSI associated with multiple APs to the multiple APs simultaneously. Alternatively, STA1 may transmit a single CSI frame carrying CSI associated with multiple APs to AP1 that STA1 is associated with and AP1 may forward the CSI to other APs. It should be understood that the scope of the present disclosure is not limited to these examples, and other frame formats are also possible. For example, if the XX identifier is carried in User Info List in the BFRP frame, STA1 may be informed to transmit CSI associated with APs in the group associated with XX.

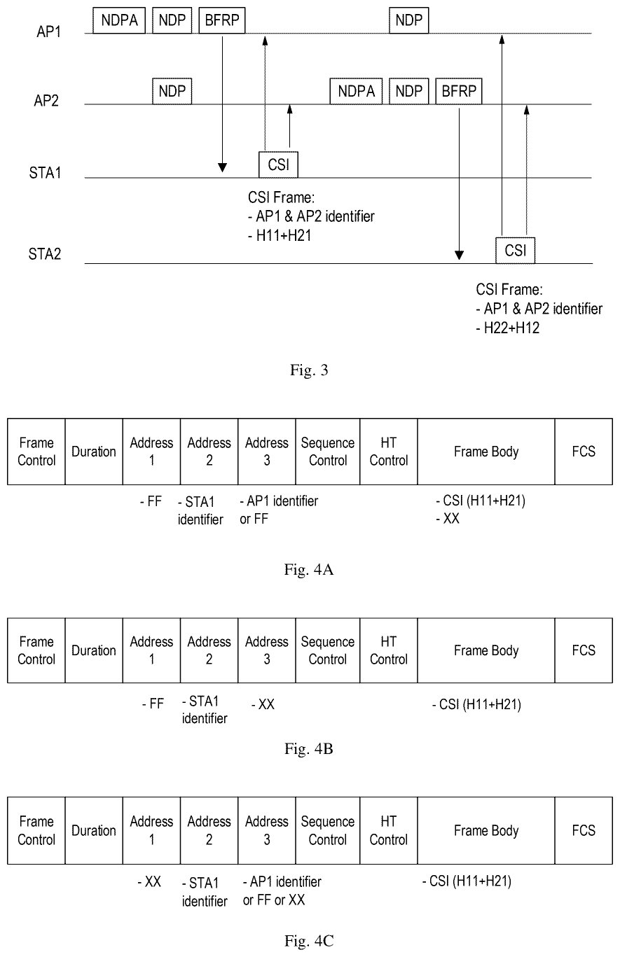

FIG. 10 shows a flowchart of an example method 1000 implemented at an apparatus in accordance with some embodiments of the present disclosure. For the purpose of discussion, the method 1000 will be described from the perspective of a non-AP STA 111 with reference to FIG. 1A.

At block 1010, the non-AP STA 111 receives, from a plurality of access point (AP) devices, a plurality of sounding sequences. At block 1020, the non-AP STA 111 determines respective channel state information (CSIs) of a plurality of channels between the non-AP STA 111 and the plurality of AP devices based on the plurality of sounding sequences. At block 1030, the non-AP STA 111 transmits, to the plurality of AP devices, a frame comprising information indicative of the respective CSIs of the plurality of channels and identifier information associated with the plurality of AP devices.

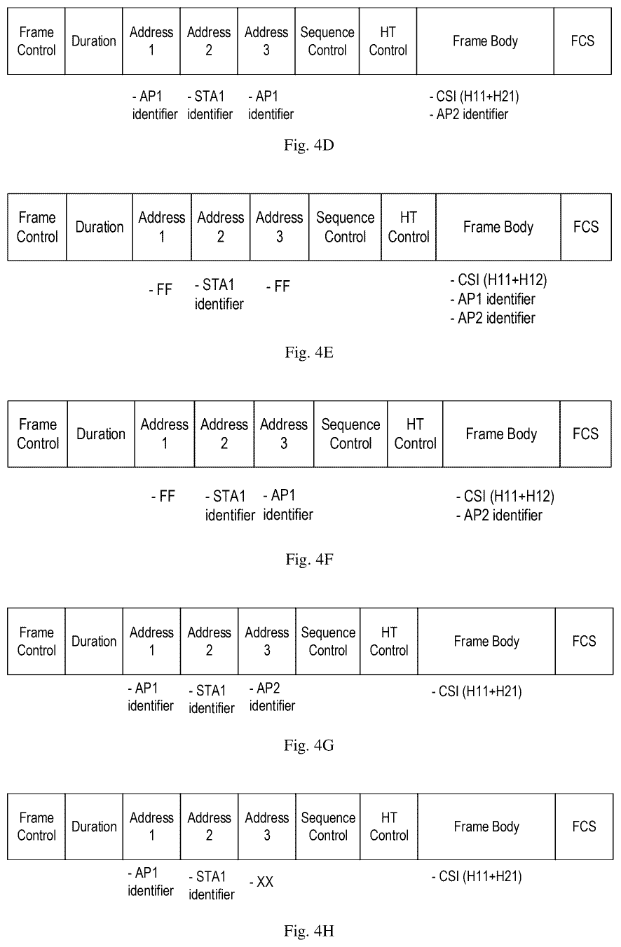

FIG. 11 shows a flowchart of an example method 1100 implemented at an apparatus in accordance with some embodiments of the present disclosure. For the purpose of discussion, the method 1100 will be described from the perspective of an AP device (AP 121 or AP 122) with reference to FIG. 1A.

At block 1110, the AP device transmits, to a non-access point (non-AP) station, a sounding sequence. At block 1120, the AP device receives, from the non-AP station, a frame comprising information indicative of respective channel state information (CSIs) of a plurality of channels between the non-AP station and a plurality of AP devices comprising the AP device and identifier information associated with the plurality of AP devices.

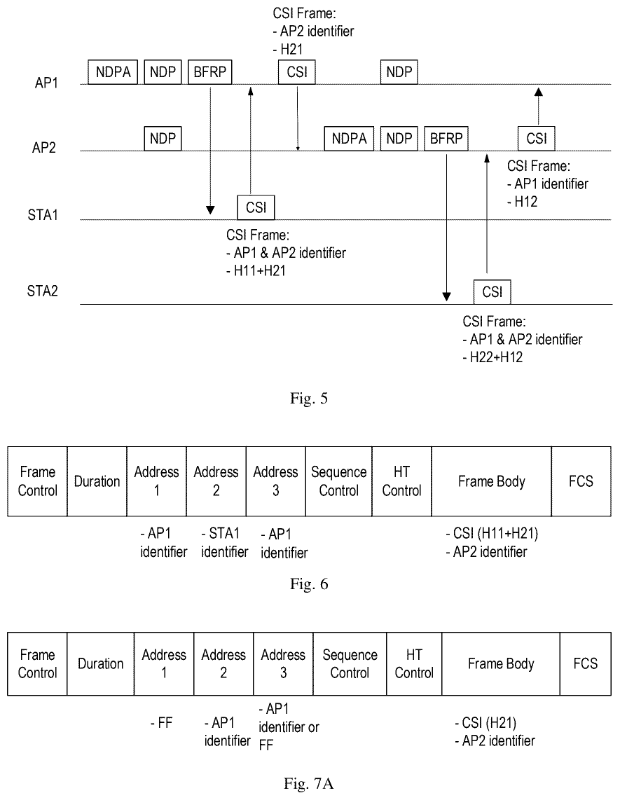

FIG. 12 shows a flowchart of an example method 1200 implemented at an apparatus in accordance with some embodiments of the present disclosure. For the purpose of discussion, the method 1200 will be described from the perspective of a non-AP STA 111 with reference to FIG. 1A.

At block 1210, the non-AP STA 111 receives, from a plurality of access point (AP) devices, a plurality of sounding sequences, wherein the plurality of AP devices comprises a first AP device and at least a second AP device. At block 1220, the non-AP STA 111 determines respective channel state information (CSIs) of a plurality of channels between the non-AP STA 111 and the plurality of AP devices based on the plurality of sounding sequences. At block 1230, the non-AP STA 111 transmits, to the first AP device, a first frame comprising information indicative of the respective CSIs of the plurality of channels and first identifier information associated with the plurality of AP devices.

In some embodiments, the first identifier information comprises one of the following: at least an identifier of the at least a second AP device; identifiers of AP devices of the plurality of AP devices; or a multicast address associated with the plurality of AP devices.

In some embodiments, an identifier of the first AP device comprises at least one of the following: an AP media access control (MAC) address of the first AP device; or an AP identity (ID) of the first AP device. An identifier of a second AP device of the at least a second AP device comprises at least one of the following: an AP media access control (MAC) address of the second AP device; or an AP identity (ID) of the second AP device.

In some embodiments, the first identifier information is carried in a frame body field of the first frame. In some embodiments, the non-AP STA 111 is associated with the first AP device and not associated with the at least a second AP device. In some embodiments, the non-AP STA 111 is a non-AP station.

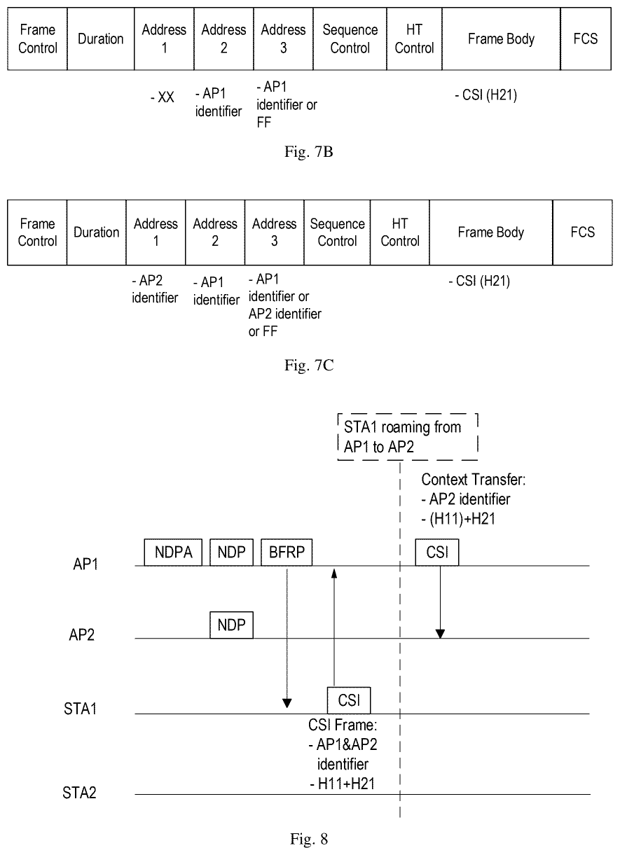

FIG. 13 shows a flowchart of an example method 1300 implemented at an apparatus in accordance with some embodiments of the present disclosure. For the purpose of discussion, the method 1300 will be described from the perspective of an AP 121 with reference to FIG. 1A.

At block 1310, the AP 121 transmits, to a non-access point (non-AP) station, a sounding sequence. At block 1320, the AP 121 receives, from the non-AP station, a first frame comprising information indicative of respective channel state information (CSI) of a plurality of channels between the non-AP station and a plurality of apparatuses comprising the AP 121 and at least a second apparatus. At block 1330, the AP 121 transmit, to the at least a second apparatus, at least a CSI of at least a channel between the non-AP station and the at least a second apparatus.

In some embodiments, the first frame further comprises first identifier information associated with the plurality of apparatuses. The first identifier information comprises one of the following: at least an identifier of the at least a second apparatus; identifiers of apparatuses of the plurality of apparatuses; or a multicast address associated with the plurality of apparatuses.

In some embodiments, the first identifier information is carried in a frame body field of the first frame.

In some embodiments, transmitting the at least a CSI of the at least a channel comprises: transmitting, to the at least a second apparatus, a second frame comprising information indicative of the at least a CSI of the at least a channel.

In some embodiments, the second frame further comprises second identifier information associated with the at least a second apparatus. The second identifier information comprises at least one of the following: at least an identifier of the at least a second apparatus; or a multicast address associated with the plurality of apparatuses.

In some embodiments, the second frame comprises: an address 1 field carrying a broadcast address; an address 3 field carrying one of the following: an identifier of the AP 121, or a broadcast address; and a frame body field carrying at least an identifier of the at least a second apparatus.

In some embodiments, the second frame comprises: an address 1 field carrying a multicast address associated with the plurality of apparatuses; and an address 3 field carrying one of the following: an identifier of the AP 121, or a broadcast address.

In some embodiments, transmitting the at least a CSI of the at least a channel comprises: transmitting, to a second apparatus of the at least a second apparatus, a second frame comprising information indicative of a CSI of a channel between the non-AP station and the second apparatus.

In some embodiments, the second frame comprises: an address 1 field carrying an identifier of the second apparatus; and an address 3 field carrying one of the following: an identifier of the AP 121, an identifier of the second apparatus, or a broadcast address.

In some embodiments, the second frame further comprises an address 2 field carrying an identifier of the AP 121.

In some embodiments, transmitting the at least a CSI of the at least a channel comprises: determining that the non-AP station roams from the AP 121 to a second apparatus among the at least a second apparatus; and based on determining that the non-AP station roams from the AP 121 to the second apparatus, transmitting, to the second apparatus, a CSI of a channel between the non-AP station and the second apparatus.

In some embodiments, the method 1300 further comprises: transmitting, to the second apparatus, a CSI of a channel between the non-AP station and the AP 121.

In some embodiments, the CSI of the channel between the non-AP station and the second apparatus is carried in a context transfer message.

In some embodiments, an identifier of the AP 121 comprises at least one of the following: an AP media access control (MAC) address of the AP 121; or an AP identity (ID) of the AP 121.

In some embodiments, an identifier of a second apparatus of the at least one second apparatus comprises at least one of the following: an AP MAC address of the second apparatus; or an AP ID of the second apparatus.

In some embodiments, the non-AP station is associated with the AP 121 and is not associated with the at least a second apparatus. In some embodiments, the AP 121 is a first AP device, the at least a second apparatus is at least a second AP device.

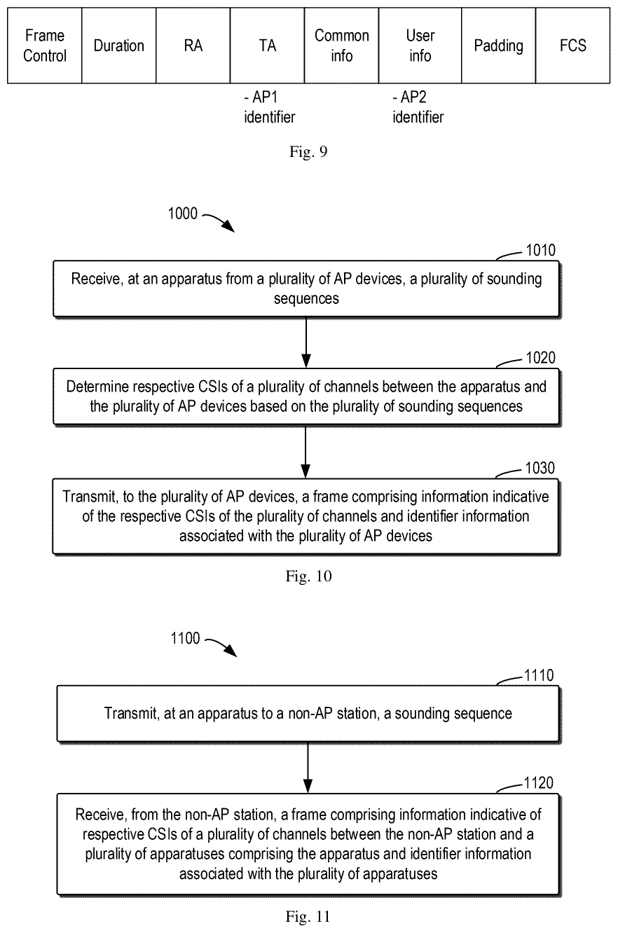

FIG. 14 shows a flowchart of an example method 1400 implemented at an apparatus in accordance with some embodiments of the present disclosure. For the purpose of discussion, the method 1400 will be described from the perspective of an AP 122 with reference to FIG. 1A.

At block 1410, the AP 122 transmits, to a non-access point (non-AP) station, a sounding sequence. At block 1420, the AP 122 receives, from a first apparatus, channel state information (CSI) of a channel between the non-AP station and the AP 122.

In some embodiments, receiving the CSI of the channel comprises: receiving, from the first apparatus, a second frame comprising information indicative of at least a CSI of at least a channel between the non-AP station and at least a second apparatus, wherein the at least a second apparatus comprises the AP 122.

In some embodiments, the second frame further comprises second identifier information associated with the at least a second apparatus. The second identifier information comprises at least one of the following: at least an identifier of the at least a second apparatus; or a multicast address associated with a plurality of apparatuses, wherein the plurality of apparatuses comprises the first apparatus and the at least a second apparatus.

In some embodiments, the second frame comprises: an address 1 field carrying a broadcast address; an address 3 field carrying one of the following: an identifier of the first apparatus, or a broadcast address; and a frame body field carrying at least an identifier of the at least a second apparatus.

In some embodiments, the second frame comprises: an address 1 field carrying a multicast address associated with a plurality of apparatuses, wherein the plurality of apparatuses comprises the first apparatus and the at least a second apparatus; and an address 3 field carrying one of the following: an identifier of the first apparatus, or a broadcast address.

In some embodiments, receiving the CSI of the channel comprises: receiving, from the first apparatus, a second frame comprising information indicative of the CSI of the channel. The second frame comprises: an address 1 field carrying an identifier of the AP 122; and an address 3 field carrying one of the following: an identifier of the first apparatus, an identifier of the AP 122, or a broadcast address.

In some embodiments, the second frame further comprises an address 2 field carrying an identifier of the first apparatus.

In some embodiments, receiving the CSI of the channel comprises: determining that the non-AP station roams from the first apparatus to the AP 122; and based on determining that the non-AP station roams from the first apparatus to the AP 122, receiving, from the first apparatus, the CSI of the channel between the non-AP station and the AP 122.

In some embodiments, the method 1400 further comprises: receiving, from the first apparatus, a CSI of a channel between the non-AP station and the first apparatus.

In some embodiments, the CSI of the channel between the non-AP station and the AP 122 is carried in a context transfer message.

In some embodiments, an identifier of the first apparatus comprises at least one of the following: an AP media access control (MAC) address of the first apparatus; or an AP identity (ID) of the first apparatus.

In some embodiments, an identifier of the AP 122 of the at least one AP 122 comprises at least one of the following: an AP MAC address of the AP 122; or an AP ID of the AP 122.

In some embodiments, the non-AP station is associated with the first apparatus and is not associated with the AP 122. In some embodiments, the first apparatus is a first AP device, and the AP 122 is a second AP device.

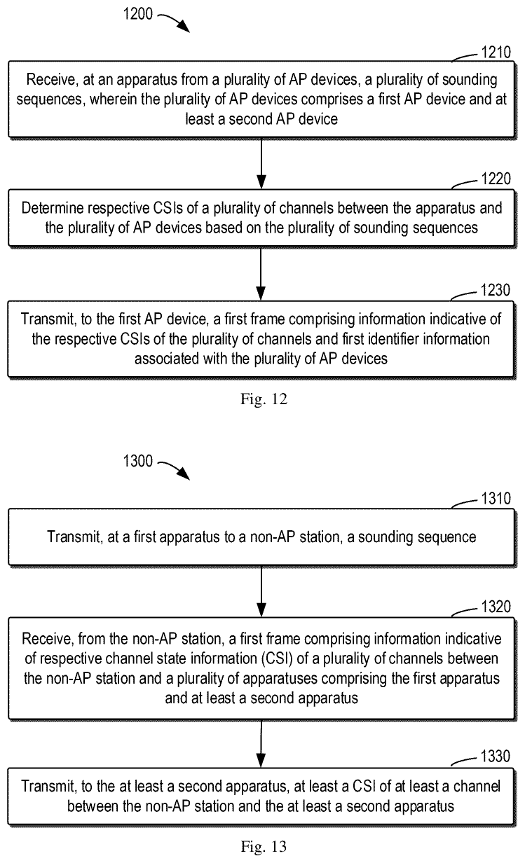

FIG. 15 shows a flowchart of an example method 1500 implemented at an apparatus in accordance with some embodiments of the present disclosure. For the purpose of discussion, the method 1500 will be described from the perspective of non-AP STA 211 with reference to FIG. 1A.

At block 1510, the non-AP STA 111 receives, from a plurality of access point (AP) devices, a plurality of sounding sequences, wherein the plurality of AP devices comprises a first AP device and at least a second AP device. At block 1520, the non-AP STA 111 receives, from the first AP device, a trigger frame comprising identifier information associated with the plurality of AP devices. At block 1530, the non-AP STA 111 transmits, to the first AP device or to the plurality of AP devices, a frame comprising information indicative of respective channel state information (CSIs) of a plurality of channels between the non-AP STA 111 and the plurality of AP devices.

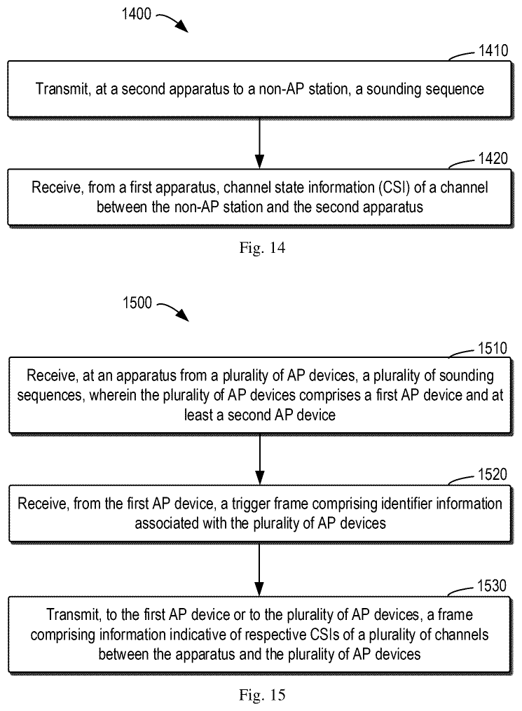

FIG. 16 shows a flowchart of an example method 1600 implemented at an apparatus in accordance with some embodiments of the present disclosure. For the purpose of discussion, the method 1600 will be described from the perspective of the AP 121 with reference to FIG. 1A.

At block 1610, the AP 121 transmits, to a non-access point (non-AP) station, a sounding sequence. At block 1620, the AP 121 transmits, to the non-AP station, a trigger frame, wherein the trigger frame comprises identifier information associated with a plurality of apparatuses comprising the AP 121 and at least a second apparatus. At block 1630, the AP 121 receives, from the non-AP station, a frame comprising information indicative of respective channel state information (CSIs) of a plurality of channels between the non-AP station and a plurality of apparatuses.

In some embodiments, an apparatus capable of performing any of the method 1000 (for example, a non-AP STA 111) may comprise means for performing the respective steps of the method 1000. The means may be implemented in any suitable form. For example, the means may be implemented in a circuitry or software module.

In some embodiments, the apparatus comprises means for receiving, from a plurality of access point (AP) devices, a plurality of sounding sequences; means for determining respective channel state information (CSIs) of a plurality of channels between the apparatus and the plurality of AP devices based on the plurality of sounding sequences; and means for transmitting, to the plurality of AP devices, a frame comprising information indicative of the respective CSIs of the plurality of channels and identifier information associated with the plurality of AP devices.

In some embodiments, the apparatus further comprises means for performing other steps in some embodiments of the method 1000. In some embodiments, the means comprises at least one processor; and at least one memory including computer program code, the at least one memory and computer program code configured to, with the at least one processor, cause the performance of the apparatus.

In some embodiments, an apparatus capable of performing any of the method 1100 (for example, AP 121 or AP 122) may comprise means for performing the respective steps of the method 1100. The means may be implemented in any suitable form. For example, the means may be implemented in a circuitry or software module.

In some embodiments, the apparatus comprises: means for transmitting, to a non-access point (non-AP) station, a sounding sequence; and means for receiving, from the non-AP station, a frame comprising information indicative of respective channel state information (CSIs) of a plurality of channels between the non-AP station and a plurality of apparatuses comprising the apparatus and identifier information associated with the plurality of apparatuses.

In some embodiments, the apparatus further comprises means for performing other steps in some embodiments of the method 1100. In some embodiments, the means comprises at least one processor; and at least one memory including computer program code, the at least one memory and computer program code configured to, with the at least one processor, cause the performance of the apparatus.

In some embodiments, an apparatus capable of performing any of the method 1200 (for example, a non-AP STA 111) may comprise means for performing the respective steps of the method 1200. The means may be implemented in any suitable form. For example, the means may be implemented in a circuitry or software module.

In some embodiments, the apparatus comprises means for receiving, from a plurality of access point (AP) devices, a plurality of sounding sequences, wherein the plurality of AP devices comprises a first AP device and at least a second AP device; means for determining respective channel state information (CSIs) of a plurality of channels between the apparatus and the plurality of AP devices based on the plurality of sounding sequences; and means for transmitting, to the first AP device, a first frame comprising information indicative of the respective CSIs of the plurality of channels and first identifier information associated with the plurality of AP devices.

In some embodiments, the apparatus further comprises means for performing other steps in some embodiments of the method 1200. In some embodiments, the means comprises at least one processor; and at least one memory including computer program code, the at least one memory and computer program code configured to, with the at least one processor, cause the performance of the apparatus.

In some embodiments, an apparatus capable of performing any of the method 1300 (for example, AP 121) may comprise means for performing the respective steps of the method 1300. The means may be implemented in any suitable form. For example, the means may be implemented in a circuitry or software module.

In some embodiments, the apparatus comprises: means for transmitting, to a non-access point (non-AP) station, a sounding sequence; means for receiving, from the non-AP station, a first frame comprising information indicative of respective channel state information (CSI) of a plurality of channels between the non-AP station and a plurality of apparatuses comprising the first apparatus and at least a second apparatus; and means for transmitting, to the at least a second apparatus, at least a CSI of at least a channel between the non-AP station and the at least a second apparatus.

In some embodiments, the apparatus further comprises means for performing other steps in some embodiments of the method 1300. In some embodiments, the means comprises at least one processor; and at least one memory including computer program code, the at least one memory and computer program code configured to, with the at least one processor, cause the performance of the apparatus.

In some embodiments, an apparatus capable of performing any of the method 1400 (for example, AP 122) may comprise means for performing the respective steps of the method 1400. The means may be implemented in any suitable form. For example, the means may be implemented in a circuitry or software module.

In some embodiments, the apparatus comprises: means for transmitting, to a non-access point (non-AP) station, a sounding sequence; and means for receiving, from a first apparatus, channel state information (CSI) of a channel between the non-AP station and the second apparatus.

In some embodiments, the apparatus further comprises means for performing other steps in some embodiments of the method 1400. In some embodiments, the means comprises at least one processor; and at least one memory including computer program code, the at least one memory and computer program code configured to, with the at least one processor, cause the performance of the apparatus.

In some embodiments, an apparatus capable of performing any of the method 1500 (for example, a non-AP STA 111) may comprise means for performing the respective steps of the method 1500. The means may be implemented in any suitable form. For example, the means may be implemented in a circuitry or software module.

In some embodiments, the apparatus comprises means for receiving, from a plurality of access point (AP) devices, a plurality of sounding sequences, wherein the plurality of AP devices comprises a first AP device and at least a second AP device; means for receiving, from the first AP device, a trigger frame comprising identifier information associated with the plurality of AP devices; and means for transmitting, to the first AP device or to the plurality of AP devices, a frame comprising information indicative of respective channel state information (CSIs) of a plurality of channels between the apparatus and the plurality of AP devices.

In some embodiments, the apparatus further comprises means for performing other steps in some embodiments of the method 1500. In some embodiments, the means comprises at least one processor; and at least one memory including computer program code, the at least one memory and computer program code configured to, with the at least one processor, cause the performance of the apparatus.

In some embodiments, an apparatus capable of performing any of the method 1600 (for example, AP 121) may comprise means for performing the respective steps of the method 1600. The means may be implemented in any suitable form. For example, the means may be implemented in a circuitry or software module.

In some embodiments, the apparatus comprises: means for transmitting, to a non-access point (non-AP) station, a sounding sequence; means for transmitting, to the non-AP station, a trigger frame, wherein the trigger frame comprises identifier information associated with a plurality of apparatuses comprising the first apparatus and at least a second apparatus; and means for receiving, from the non-AP station, a frame comprising information indicative of respective channel state information (CSIs) of a plurality of channels between the non-AP station and a plurality of apparatuses.

In some embodiments, the apparatus further comprises means for performing other steps in some embodiments of the method 1600. In some embodiments, the means comprises at least one processor; and at least one memory including computer program code, the at least one memory and computer program code configured to, with the at least one processor, cause the performance of the apparatus.

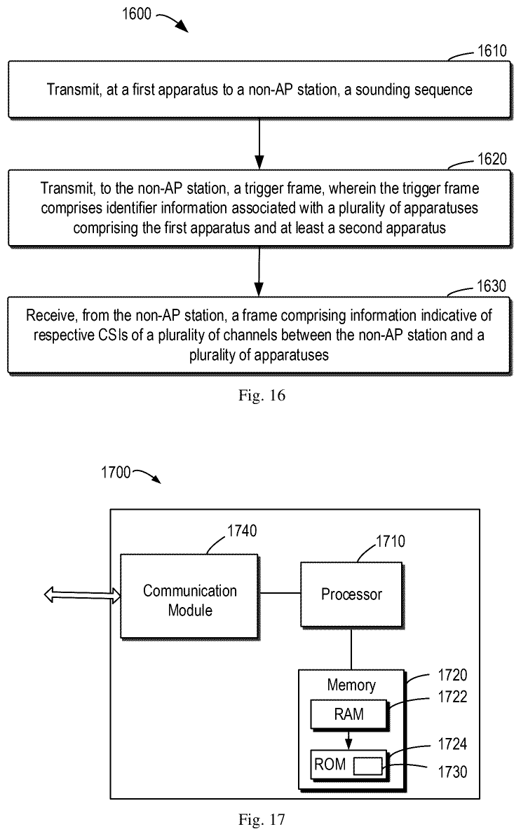

FIG. 17 is a simplified block diagram of a device 1700 that is suitable for implementing embodiments of the present disclosure. The device 1700 may be provided to implement the communication device, for example non-AP STA 111, AP 121 or AP 122 as shown in FIG. 1A. As shown, the device 1700 includes one or more processors 1710, one or more memories 1740 coupled to the processor 1710, and one or more transmitters and/or receivers (TX/RX) 1740 coupled to the processor 1710.

The TX/RX 1740 is for bidirectional communications. The TX/RX 1740 has at least one antenna to facilitate communication. The communication interface may represent any interface that is necessary for communication with other network elements.

The processor 1710 may be of any type suitable to the local technical network and may include one or more of the following: general purpose computers, special purpose computers, microprocessors, digital signal processors (DSPs) and processors based on multicore processor architecture, as non-limiting examples. The device 1700 may have multiple processors, such as an application specific integrated circuit chip that is slaved in time to a clock which synchronizes the main processor.

The memory 1720 may include one or more non-volatile memories and one or more volatile memories. Examples of the non-volatile memories include, but are not limited to, a Read Only Memory (ROM) 1724, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 1722 and other volatile memories that will not last in the power-down duration.

A computer program 1730 includes computer executable instructions that are executed by the associated processor 1710. The program 1730 may be stored in the ROM 1020. The processor 1710 may perform any suitable actions and processing by loading the program 1730 into the RAM 1020.

The embodiments of the present disclosure may be implemented by means of the program 1730 so that the device 1700 may perform any process of the disclosure as discussed with reference to FIGS. 2A to 16. The embodiments of the present disclosure may also be implemented by hardware or by a combination of software and hardware.

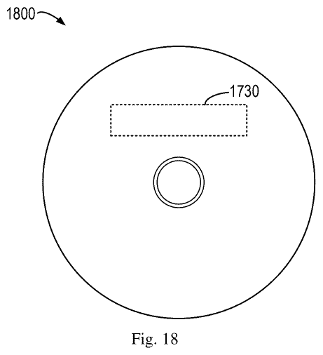

In some embodiments, the program 1730 may be tangibly contained in a computer readable medium which may be included in the device 1700 (such as in the memory 1720) or other storage devices that are accessible by the device 1700. The device 1700 may load the program 1730 from the computer readable medium to the RAM 1722 for execution. The computer readable medium may include any types of tangible non-volatile storage, such as ROM, EPROM, a flash memory, a hard disk, CD, DVD, and the like. FIG. 18 shows an example of the computer readable medium 1800 in form of CD or DVD. The computer readable medium has the program 1730 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method 1700 as described above with reference to FIGS. 2A-16. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. The term “non-transitory,” as used herein, is a limitation of the medium itself (i.e., tangible, not a signal) as opposed to a limitation on data storage persistency (e.g., RAM vs. ROM).

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. An apparatus, comprising:
at least one processor; and
at least one memory storing instructions that, when executed by the at least one processor, cause the apparatus at least to:
receive, from a plurality of access point (AP) devices, a plurality of sounding sequences, wherein the plurality of AP devices comprises a first AP device and at least a second AP device;
determine respective channel state information (CSIs) of a plurality of channels between the apparatus and the plurality of AP devices based on the plurality of sounding sequences; and
transmit, to the first AP device, a first frame comprising information indicative of the respective CSIs of the plurality of channels and first identifier information associated with the plurality of AP devices.

2. The apparatus of claim 1, wherein the first identifier information comprises one of the following:
at least an identifier of the at least a second AP device;
identifiers of AP devices of the plurality of AP devices; or
a multicast address associated with the plurality of AP devices,
wherein the first identifier information is carried in a frame body field of the first frame.

3. The apparatus of claim 1 or 2, wherein the apparatus is associated with the first AP device and not associated with the at least a second AP device, wherein the apparatus is a non-AP station.

4. A first apparatus comprising:
at least one processor; and
at least one memory storing instructions that, when executed by the at least one processor, cause the first apparatus at least to:
transmit, to a non-access point (non-AP) station, a sounding sequence;
receive, from the non-AP station, a first frame comprising information indicative of respective channel state information (CSI) of a plurality of channels between the non-AP station and a plurality of apparatuses comprising the first apparatus and at least a second apparatus; and
transmit, to the at least a second apparatus, at least a CSI of at least a channel between the non-AP station and the at least a second apparatus.

5. The first apparatus of claim 4, wherein the first frame further comprises first identifier information associated with the plurality of apparatuses, and the first identifier information comprises one of the following:
at least an identifier of the at least a second apparatus;
identifiers of apparatuses of the plurality of apparatuses; or
a multicast address associated with the plurality of apparatuses.

6. The first apparatus of claim 5, wherein the first identifier information is carried in a frame body field of the first frame.

7. The first apparatus of claim 4, wherein the first apparatus is caused to transmit the at least a CSI of the at least a channel by:
transmitting, to the at least a second apparatus, a second frame comprising information indicative of the at least a CSI of the at least a channel.

8. The first apparatus of claim 7, wherein the second frame further comprises second identifier information associated with the at least a second apparatus, and the second identifier information comprises at least one of the following:
at least an identifier of the at least a second apparatus; or
a multicast address associated with the plurality of apparatuses.

9. The first apparatus of claim 7, wherein the second frame comprises:
an address 1 field carrying a broadcast address;
an address 3 field carrying one of the following:
an identifier of the first apparatus, or
a broadcast address; and
a frame body field carrying at least an identifier of the at least a second apparatus.

10. The first apparatus of claim 7, wherein the second frame comprises:
an address 1 field carrying a multicast address associated with the plurality of apparatuses; and
an address 3 field carrying one of the following:
an identifier of the first apparatus, or
a broadcast address.

11. The first apparatus of claim 4, wherein the first apparatus is caused to transmit the at least a CSI of the at least a channel by:
transmitting, to a second apparatus of the at least a second apparatus, a second frame comprising information indicative of a CSI of a channel between the non-AP station and the second apparatus.

12. The first apparatus of claim 11, wherein the second frame comprises:
an address 1 field carrying an identifier of the second apparatus; and
an address 3 field carrying one of the following:
an identifier of the first apparatus,
an identifier of the second apparatus, or
a broadcast address.

13. The first apparatus of claim 7, wherein the second frame further comprises an address 2 field carrying an identifier of the first apparatus.

14. The first apparatus of claim 5, wherein an identifier of the first apparatus comprises at least one of the following:
an AP media access control (MAC) address of the first apparatus; or
an AP identity (ID) of the first apparatus,
wherein an identifier of a second apparatus of the at least one second apparatus comprises at least one of the following:
an AP MAC address of the second apparatus; or
an AP ID of the second apparatus.

15. The first apparatus of claim 4, wherein the non-AP station is associated with the first apparatus and is not associated with the at least a second apparatus, wherein the first apparatus is a first AP device, the at least a second apparatus is at least a second AP device.

16. A second apparatus comprising:
at least one processor; and
at least one memory storing instructions that, when executed by the at least one processor, cause the second apparatus at least to:
transmit, to a non-access point (non-AP) station, a sounding sequence; and
receive, from a first apparatus, channel state information (CSI) of a channel between the non-AP station and the second apparatus.

17. The second apparatus of claim 16, wherein the second apparatus is caused to receive the CSI of the channel by:
receiving, from the first apparatus, a second frame comprising information indicative of at least a CSI of at least a channel between the non-AP station and at least a second apparatus, wherein the at least a second apparatus comprises the second apparatus.

18. The second apparatus of claim 16, wherein the second apparatus is caused to receive the CSI of the channel by:
receiving, from the first apparatus, a second frame comprising information indicative of the CSI of the channel, wherein the second frame comprises:
an address 1 field carrying an identifier of the second apparatus; and
an address 3 field carrying one of the following:
an identifier of the first apparatus,
an identifier of the second apparatus, or
a broadcast address.

19. A method comprising:
receiving, at an apparatus from a plurality of access point (AP) devices, a plurality of sounding sequences, wherein the plurality of AP devices comprises a first AP device and at least a second AP device;
determining respective channel state information (CSIs) of a plurality of channels between the apparatus and the plurality of AP devices based on the plurality of sounding sequences; and
transmitting, to the first AP device, a first frame comprising information indicative of the respective CSIs of the plurality of channels and first identifier information associated with the plurality of AP devices.

20. A method comprising:
transmitting, at a first apparatus to a non-access point (non-AP) station, a sounding sequence;
receiving, from the non-AP station, a first frame comprising information indicative of respective channel state information (CSI) of a plurality of channels between the non-AP station and a plurality of apparatuses comprising the first apparatus and at least a second apparatus; and
transmitting, to the at least a second apparatus, at least a CSI of at least a channel between the non-AP station and the at least a second apparatus.

21. A method comprising:
transmitting, at a second apparatus to a non-access point (non-AP) station, a sounding sequence; and
receiving, from a first apparatus, channel state information (CSI) of a channel between the non-AP station and the second apparatus.
